(19) United States
(12) Patent Application Publication
(10) Pub. No.: US 2011/0250043 A1
(43) Pub. Date: Oct. 13, 2011

(54) LIFTING SYSTEMS FOR HIGH-RISE BUILDINGS

(76) Inventors: Pavel V. Korchagin, Moscow (RU); Marina E. Korchagina, Moscow (RU); Andrey G. Tirskiy, Moscow (RU)

(21) Appl. No.: 13/101,105

(22) Filed: May 4, 2011

Related U.S. Application Data
(62) Division of application No. 11/567,596, filed on Dec. 6, 2006, now abandoned.

(30) Foreign Application Priority Data
Jul. 25, 2005 (RU) RU2005123483
Feb. 17, 2006 (RU) RU2006104888
Jun. 19, 2006 (EA) PCT/EA2006/000010

(51) Int. Cl. B66F 11/00; B66C 23/26; B66B 9/00

(52) U.S. Cl. 414/560

(57) ABSTRACT

Elevators for use during construction, maintenance and emergency evacuation which ride on rails on the outside perimeter of buildings are proposed. The rails can be on flat or curved walls. Building setbacks may have movable rail sections connecting the setback wall with the outer perimeter wall for the elevator to travel up the side of the building. Trusses on the elevators can support a crane. A turntable on the elevator can work in conjunction with the elevator and the crane to install or remove trusses for supporting the crane. During emergencies people can escape buildings and fire fighting equipment and personnel can enter building using the outside elevators. Construction safety may be improved by use of the easy to assemble, disassemble and move crane. The elevator cars may be easily attached to rails on the outside of buildings when needed and removed, transported and stored when not needed.

### BACKGROUND OF THE INVENTION

The invention belongs to the area of elevators, cranes and lifting equipment, particularly, to the systems of transportation, evacuation and rescuing of people, primarily, from high-rise buildings, and can also be used in construction, fire extinguishing and maintenance of high-rise buildings.

### FIELD OF THE INVENTION

At present, vertical transportation in high-rise structures is mostly limited with stairways and elevators, of which those with the highest reach achieve the altitude level of only 70-90 meters. Effectiveness of fire-fighting installed on the outside of a construction is restricted by height of the ladders used in extinguishing fire and for evacuating people. In performing constructing and operating works, opportunities to access the walls from outside and the roof of the building are limited. For instance, in window washing, timber floorings (the so-called monkey boards) are primarily used, which unsafely hang down on straps fastened in the upper part of a structure. It is often that during construction of buildings, problems occur with erection of scaffoldings, and no vehicles exist to ensure people's access to a façade of a high-rise construction.

A device is known that is used to conduct fire-fighting and rescuing operations, which comprises a vehicle that carries a telescopic column with its extension mechanism and facilities to accommodate evacuees (RU 2079312 A, published on 20 May 1997).

Functionalities of such a device are limited by that it cannot be used to rescue people and perform fire-fighting operations on high-rise constructions with height of over 90 meters, which are often called skyscrapers.

The evacuating system for high-rise buildings is also known that comprises rails mounted on the wall of the building, along which a cabin can move in order to deliver to the location of fire, firemen and rescuers, and to evacuate people from a fire area. The rail along which the cabin moves has H-shape in its cross-section, and there are teeth used to contact with driving cog-wheels (U.S. Pat. No. 4,865,155, issued Sep. 12, 1989).

The system allows performing operations related to fire-extinguishing and evacuation of people only in the area where the rail is located which significantly limits opportunities of its utilization in case of arbitrary configuration of a building's walls.

### SUMMARY OF THE INVENTION

This invention is aimed at resolving the engineering task of enabling transportation of a moving object on outer plane of a construction and an opportunity for it to shift from vertical movement to horizontal movement with any configuration of walls of a construction, including curvilinear configuration, and the task of ensuring minimization of physical loads on the structure of a building during movement on a rail of the moving object and its use as a lifting crane of the tower type.

The technical result achievable through using the proposed invention consists in increasing the efficiency and broadening of operational capacities during maintenance of high-rise projects due to enabling weight and people transportation along the outer surfaces of a building and towards its roof with any wall configuration, supplying of auxiliary (including fire-fighting) equipment to any point of a building's outside, evacuation of people from a construction in event of fire or other emergencies, as well as minimization of physical loads on the structure of a building during movement on a rail of the moving object and its use as a lifting crane of the tower type.

The above technical result is achieved due to the fact that the lifting system for maintenance of high-rise buildings, which walls are made with projections, comprises the first rail mounted on the first section of a wall and the second on the second wall section, both rails being located at a distance, and a hoisting tackle provided with a device to fasten it to a rail and a device for its movement in relation to the rail, which system is distinguished by that it has a device to shift the hoisting tackle made as the third rail placed between the first and second ones and a device, which is attached to the third rail, and used to move this third rail between two extreme positions, in the first of which this third rail is docked, along its length, with the first rail and represent the extension of the first rail used to shift the hoisting tackle from the first rail to the third rail, and in the second extreme the third rail is docked along its length with the second rail and represents an extension of the second rail in order to shift the hoisting tackle from the third to the second rail.

The device used to fasten the hoisting tackle to the rail is made as two groups of support wheels, each of which consists of at least one wheel, and the rotation axis of the support wheels are perpendicular to at least one plane, in which at least one longitudinal axis of a rail is located; the wheels of the first group are provided with the opportunity to contact the first bearing area of the rail, which area is opposite to at least one of the second bearing areas of the rail, and the wheels of the second group are provided with opportunity to contact the second bearing area of the rail.

The device to fasten the hoisting tackle to a rail, includes additionally the third group of wheels, rotation axes of which are perpendicular to at least one plane, in which at least one longitudinal axis of a rail, and the support wheels of the third group are provided with the opportunity to contact at least one third bearing area of the rail, mated with one of the second bearing areas of the rail and located on the angle to the said second bearing area of the rail.

The device to move the hoisting tackle is made as a cog-wheel connected to a drive, position of teeth in which corresponds to position of teeth made on each of the above rails along their lengths. Otherwise, it can be made in a form of at least one of the support wheels and consist of a cog-wheel connected to a drive, position of teeth of which corresponds to position of teeth made on a rail along its length.

Each rail is made as a major component with uniform section, to which a rack is rigidly fastened with teeth along its length.

The device to move the hoisting tackle is made as a rubber-bonded wheel connected to a drive pressed on a rail with the effort sufficient to exclude slippage of the wheel against the rail. Otherwise, the device to move the hoisting tackle is made as at least one of the rubber-bonded support wheels connected to a drive and installed as to ensure that pressing of the wheel to the rail is conducted with the effort that excludes slippage of the said wheel against the rail. Otherwise, the device to move the hoisting tackle is made as a rope equipped with its moving device, for instance, as a winch.

The hoisting tackle is provided with a safety brake provided with possibility to enable deceleration and stop of the hoisting tackle in event of breakdown of the hoisting-tackle moving device.

The system also comprises an additional hoisting tackle similar to the above hoisting tackle.

Within the system, a controlled pullout two-position stop is provided near to at least one end of at least one of the rails. In its first position, the controlled stop hinders movement of the hoisting tackle and the additional hoisting tackle off the relevant rail, and in the second position, the controlled stop does not hinders moving of the said tackles off the rail. The system includes the third-rail position transducer connected to the input of at least one control unit of the controlled stops, which ensures shifting into the second position of the controlled units located at mated ends of rails and shifting to the third position of all other controlled stops.

System rails can be H-shaped.

A hoisting tackle can be made as a platform.

The third-rail moving device comprises at least one linear drive, a fixed part of which is attached to the high-rise building, while a moving part to the third rail. The hoisting tackle shifting device is provided with a support section fastened to the third rail to enable alternate motion of the third rail between the first and second rails. The support section is made as guides fixedly attached between edges of the walls which edges are located closely, and the support wheels attached to the third rail are located on the guides.

A self-contained traveling vehicle may be included into the system, on which an auxiliary rail will be fastened movably in order to enable mating of the third rail to at least either the first or the second rails so that the auxiliary rail makes the extension of a relevant rail. Otherwise the system may include a self-contained traveling vehicle equipped with the fastening and moving devices for the hoisting tackle that will enable delivery and returning of the hoisting tackle as well as its retention at a rail during operations of attaching and detaching of the hoisting tackle to/from that rail.

In order to ensure minimization of physical loads on a building's structure during movements of hoisting tackles on each of the rails, the system is provided with a metal load-bearing skeleton that is installed in a well inside the high-rise building's perimeter and forms a vertical structure of a tower-crane type, on which a rail is rigidly fastened. In order to minimize vibration transferred to the building's structure during movements of hoisting tackles on each of the rails, the load-bearing skeleton is connected with the load-bearing elements of the building via damping buckles. In order to ensure sound insulation for the rooms in the building that abut with the area of installation of a rail, such rail will be fastened to the load-bearing skeleton via a metal sheath. In order to provide the rooms in the building that abut with the area of installation of a rail with thermal impact effect protection, a free clearance is provided between the load-bearing skeleton and the building's wall which acts as an air cushion. In order to protect the vertical tower-type structure and the building's walls from weather factors' exposure, the load-bearing skeleton with a rail inside will be closed at its full length with expanding folds. In order to enable utilization of rooms that abut inside the building to the rail installation area as self-contained functional rooms for purpose of people's safe sheltering and evacuating, the metal load-bearing skeleton is divided into autonomous sections.

To enable admission of people to each of the autonomous sections, the sections are connected between each other with stairways and/or evacuation inter-floor grounds, and/or intermediate stairway grounds. In order to enable communication of each autonomous section with parallel floors of the building, the load-bearing skeleton is covered from outside with heat-resistant casing which is provided in the areas of location of the grounds of autonomous sections with doorways. In order to ensure safety of people during passing via adjacent doorways, a hermetic seal is laid along the perimeter of connection of the adjacent doorways. In order to protect the autonomous sections from adverse exposures, the doorways are equipped with hermetically closed doors made of heat-resistant material.

In order to ensure communication of each autonomous section with internal compartments of the installed-in-parallel hoisting tackles, evacuation exits of the building are provided in the heat-resistant casing of the metal load-bearing skeleton in the areas of the rail location. In order to ensure protection of the autonomous sections and internal compartments of the hoisting tackles from adverse exposures, the evacuation exits are equipped with hermetically closed doors made of heat-resistant material. In order to ensure protection of the autonomous sections from adverse exposures, the autonomous sections are isolated from each other with hermetic heat-resistant wall partitions and inter-stairway walls. In order to enable communication between areas of the autonomous sections insulated with use of partitions and walls, the wall partitions are provided with hermetically closed doors made of heat-resistant material.

In order to ensure rigid connection of a hoisting tackle with the structure of the building, which is necessary in order to increase stability and carrying capacity of the hoisting tackle, the autonomous section is provided with take-up casings, which interact with the supporting elements of the hoisting tackle; otherwise the hoisting tackle is provided with take-up casings which interact with supporting elements of the autonomous section. In order to enable temporary rigid connection of the hoisting tackle with the building's structure that is required in order to increase stability and carrying capacity of the hoisting tackle at the moment of such connection, the supporting elements are positioned within the guiding casings of the autonomous section and are telescoped into the take-up casings of the hoisting tackle either manually or by means of screw-jack devices; otherwise the supporting elements are positioned within the guiding casings of the hoisting tackle and are telescoped into the take-up casings of the autonomous section, either manually or by means of screw-jack devices. In order to ensure temporary rigid connection of the hoisting tackle with the building's structure on a selected area of the vertically-mounted rail, which is required in order to increase stability and carrying capacity of the hoisting tackle at the moment of such connection, the guiding casings with the supporting elements inside them are provided at every level of the building along the length of the vertical rail; otherwise the take-up casings are provided at every level of the building along the length of the vertical rail.

In order to enable using the hoisting tackle as a lifting tower crane, a vertical tower-type truss is installed on top of the upper horizontal surface of the hoisting tackle, on top end of which a turntable, an outrigger, an operator's cabin and hauling and lifting mechanisms are installed. In order to minimize physical loads on the rail when using the lifting tower crane, the system comprises at least two hoisting tackles, rigidly connected to each other with use of an additional vertical truss of the tower type.

The vertical tower-type trusses consist of collapsible sections that can be assembled by means of mounting pins, grooves, openings and screw couplings. A hoisting tackle has, on its outside horizontal surfaces, mounting pads with which mounting frames of collapsible sections are in contact. In order to ensure precise positioning of the sections of the vertical tower-type trusses on the outside horizontal surfaces, on its upper horizontal surface grooves are provided which fit with mounting pins of the sections, while the lower horizontal surface of the hoisting tackle is provided with removable mounting pins which fit with sections' grooves.

In order to provide access by the personnel to the outside horizontal surfaces of a hoisting tackle, the hoisting tackle is provided with a cabin divided by an inter-floor ground into the upper and lower levels, of which the first communicates with the mounting pad of the upper horizontal surface via an aperture and a hatch, and the second communicates with the mounting pad of the lower horizontal surface via an aperture and a hatch. The levels are connected between them with a ladder through an aperture in the inter-level ground. in order to ensure communication between the inside compartment of the hoisting tackle and an autonomous section, tambours are provided on outside surface of the hoisting tackle mating the building, which tambours communicate with the building's evacuation exists. In order to enable communication between the internal compartment of the hoisting tackle and the outside surface of the hoisting tackle that does not mate to the building, a hermetically closed door is used.

In order to enable using a hoisting tackle as a lifting tower-type crane, the system is equipped with a docking device for purpose of mechanical installation of a removable rail section on the wall of the building. The docking device represents a pullout frame installed in the building's compartment and connected to the screw-jack devices that move the pullout frame beyond the outer dimensions of the building. The pullout frame is equipped with support wheels which contact the guides provided in the surfaces of the compartment. The pullout frame has, in its frontal part, a take-up panel with overlay guides provided on its left- and right-hand sides. In order to enable connection with the take-up panel, the removable rail section is equipped with a mounting panel that repeats after the design of the take-up panel, and thickness of the mounting panel is less than clearance between the overlay guides and the outer surface of the take-up panel is.

To enable overcoming by the hoisting tackles of horizontal cornices of the building, the cornices are equipped with transfer junctions. In respect to horizontal cornices up to 3 meter wide, a transfer junction represents a functional compartment of the building in which a pullout frame is installed connected to screw-jack devices, with use of which the pullout frame can move from the functional compartment outside, beyond the building plane's outer dimensions. The pullout frame is equipped with support wheels which contact the guides made in the outer surface of a cornice and in the upper part of the functional compartment. The pullout frame has, in its frontal part, an external panel with a movable rail section installed on it. In respect to horizontal cornices over 3 meters wide, for buildings with the projection-shaped outer surfaces, a transfer junction is a functional compartment of the building in which a self-propelled module is placed equipped with motor unit required in order to drive cog-wheels contacting with the rack-guides. The self-propelled module can move from the functional compartment outside, beyond outer dimensions of the building plane, on support wheels which contact with guides provided on external surface of the cornice of the building serviced. The self-propelled module has in its frontal part an external panel with a movable rail section provided on it.

In order to enable using a hoisting tackle as a lifting tower-type crane, the external plane of the hoisting tackle is provide with a removable frame, which is fixedly connected via a rotary connector assembly with a mounting turntable. Mechanized rotation of the mounting turntable on 180° in respect to symmetry axis of the hoisting tackle is enabled by that the turntable is equipped with a rotary frame movably connected via a rotary block with a hauling gear of the lifting mechanism installed in the upper part of the removable frame. The mounting turntable is movably connected via its lower surface, with hauling gears of lifting mechanisms located in the support shafts.

The specified technical results is also achieved due to that the lifting system for service of high-rise buildings with curvilinear profile of their external surfaces comprises vertically positioned rails mounted on outer surfaces of such buildings, which repeat after the curvilinear profile of the outer surfaces, and a hoisting tackle for each rail equipped with a device to fasten it to the rail and a device to move it on the rail, and is characterized with that the fastening and moving devices are installed in the dolly of the running gear of the hoisting tackle that is movably connected with the hoisting tackle by means of hinged swivel blocks and screw-jack guides.

An elastic corrugated jacket is provided in the opening between the running gear dolly and the hoisting tackle.

The rails along the height of the building are placed at a distance from one another, in a circular direction around the outer surface of the building, and at least at two areas sequentially located along the height of the building, with an individual hoisting tackle associated with each rail.

The rails have H-shaped profile.

The device used to fasten the hoisting tackle to the H-shaped rail is made as two groups of support wheels, each of which consists of at least one wheel, and the rotation axes of the support wheels are perpendicular to at least one plane, in which at least one longitudinal axis of a rail is located; the wheels of the first group are provided with the opportunity to contact the first bearing area of the rail, which area is opposite to at least one of the second bearing areas of the rail, and the wheels of the second group are provided with opportunity to contact the second bearing area of the rail.

The device to fasten the hoisting tackle to the H-shaped rail, includes additionally the third group of wheels, rotation axes of which are perpendicular to at least one plane, in which at least one longitudinal axis of a rail, and the support wheels of the third group are provided with the opportunity to contact at least one third bearing area of the rail, mated with one of the second bearing areas of the rail and located on the angle to the said second bearing area of the rail.

The support wheels are fastened at the surfaces of the running gear dolly via, at least, springs.

Distance between the support wheel groups provided on the running-gear dolly of the hoisting tackle, is sufficient to enable passing along the rail with curvilinear profile of its body that has curvature characteristics to be determined for a particular building where the system will be installed.

The hoisting tackle cabin is equipped with heat-resistant hermetically-closed windows and doors.

The rail is mounted with its internal surface on metal consoles installed at a distance from each other along the rail line on the building's surface, and the length of the consoles is as to ensure that the rail is placed on top of functional elements and superstructures of the building.

Rails are fixed on the metal consoles via damping elements.

On each individual section of a rail, at equal intervals of its length and over the entire area of its horizontal section, temperature-compensating inserts are provided.

On roof of then hoisting tackle, an external ground with collapsible fence is provided.

In the roof of the hoisting tackle, hatches are envisaged, to which ladders are attached from the inside of the internal compartment of the hoisting tackle cabin.

All the hoisting tackles of the lifting system are equipped with mechanical safety brakes that enables for them deceleration of lowering or stop in emergencies.

The rail sections are fastened with their bottom parts at least on a concrete foundation or on bearing elements of its riggings.

The rail sections are grouped into a single stanchion, which goes through the permanent riggings of the building, through openings provided in the floors of rigging bodies.

Rails are installed on or in the stanchions of the metal skeleton.

The metal skeleton's stanchions, together with rails fastened on them, are assembled on metal consoles installed along the rail line on the building surface, and the length of the consoles is as to ensure that the metal skeleton's stanchions, together with rails fastened on them, are placed on top of any functional elements of the building.

The metal skeleton's stanchions, together with rails fastened on them, are installed on the building surface.

Sections of the metal skeleton's stanchions are fastened by their bottom parts at least on a concrete foundation of the building or on bearing elements of its riggings.

Sections of the metal skeleton's stanchions are grouped into a single stanchion, which goes through the permanent riggings of the high-rise building, through opening provided in the floors of rigging bodies.

Temperature-compensating inserts are provided in the bearing elements of the structure of the metal skeleton's stanchions, over entire area of their horizontal sections and at equal vertical intervals.

Sections of the metal skeleton's stanchions that are located immediately at ground level, have an additional support made as vertical bearing elements.

On the rear surface of a rail, pipeline and electric cable are provided that function independently on similar facilities of the building.

The stand-alone systems of pipelines and power cable lines are located on the façade of the building at a distance sufficient to enable access, at least, to one of the terminals from an individual hoisting tackle as it is positioned at any altitude level of the building.

Bodies of the rails and the metal skeleton's stanchions are equipped with heating elements connected to a self-contained power-supply source.

Rail sections located immediately at ground level have additional support made as vertical bearing elements.

The above features are significant and inter-connected, forming consistent combination of essential factors sufficient to achieve the required technical result.

The distinguishing features of the proposed system were not discovered during retrieval among any known arrangements of similar destination, which is the evidence of that the technical solution meets pre-conditions of the patentability.

### BRIEF DESCRIPTION OF DRAWINGS

This invention is elucidated on specific examples which nevertheless are not the only possible options but visually demonstrate possibility of achieving by the above feature combination of the required technical result.

FIG. 1 represents the top view of cross-section of an H-shaped rail and the running gear of the hoisting tackle;

FIG. 2—rear view of hoisting tackle;

FIG. 3—top view of hoisting tackle fastened on a building with use of bearing elements of autonomous sections;

FIG. 4—top view of autonomous section (floor) of a building which is equipped with partition and inter-stairway wall;

FIG. 5—side view of vertically-installed lifting tower-type crane;

FIG. 6—side view of docking unit of a building at maximum extension of pullout frame at moment of loading hoisting tackle on it;

FIG. 7—side view of hoisting tackle where it is being fastened on metal insert of concrete foundation;

FIG. 8—top view of additional hoisting tackle;

FIG. 9—side view of self-propelled car chassis;

FIG. 10—side view of hoisting tackle equipped with mounting turntable turned at 180°;

FIG. 11—side view of hoisting tackle fastened on a building with support elements of autonomous sections;

FIG. 12—front view of hoisting tackle as it is being fastened on a building's docking unit;

FIG. 13—side view of transfer unit of a building intended for hoisting tackles to come over horizontal cornices up to 3 meters wide;

FIG. 14—view of transfer init of a building intended for hoisting tackles to come over horizontal cornices over 3 meters wide;

FIG. 15—side view of hoisting tackle equipped with mounting turntable;

FIG. 16—front view of self-propelled unit equipped with mounting turntable;

FIG. 17—side view of self-propelled unit with section of vertical tower-type truss installed on its mounting turntable;

FIG. 18—view of section of vertical tower-type truss equipped with mounting balconies;

FIG. 19—front view of self-propelled unit equipped with horizontal platform;

FIG. 20—building erection stage when docking unit with self-propelled unit is installed;

FIG. 21—building erection stage when self-propelled unit is fixed to metal insert;

FIG. 22—building erection stage when second self-propelled unit is installed;

FIG. 23—building erection stage when sections of vertical truss are mounted on upper surface of second self-propelled unit;

FIG. 24—building erection stage when second self-propelled unit is fixed to metal insert in order to continue erecting building's floors;

FIG. 25—building erection stage when six new sections of vertical tower-type truss are installed between the first and second self-propelled units;

FIG. 26—top view of self-propelled unit installed on H-shaped rail;

FIG. 27—side view of self-propelled unit installed on H-shaped rail;

FIG. 28—side view of fragment of H-shaped equipped on metal skeleton stanchion;

FIG. 29—side view of TV-tower section;

FIG. 30—Section A-A;

FIG. 31—dynamics of motion of a self-propelled hoisting tackle intended for exploitation of curvilinear surfaces of a building is demonstrated.

### DESCRIPTION OF THE PREFERRED EMBODIMENTS

This invention is illustrated with specific examples that are discussed below.

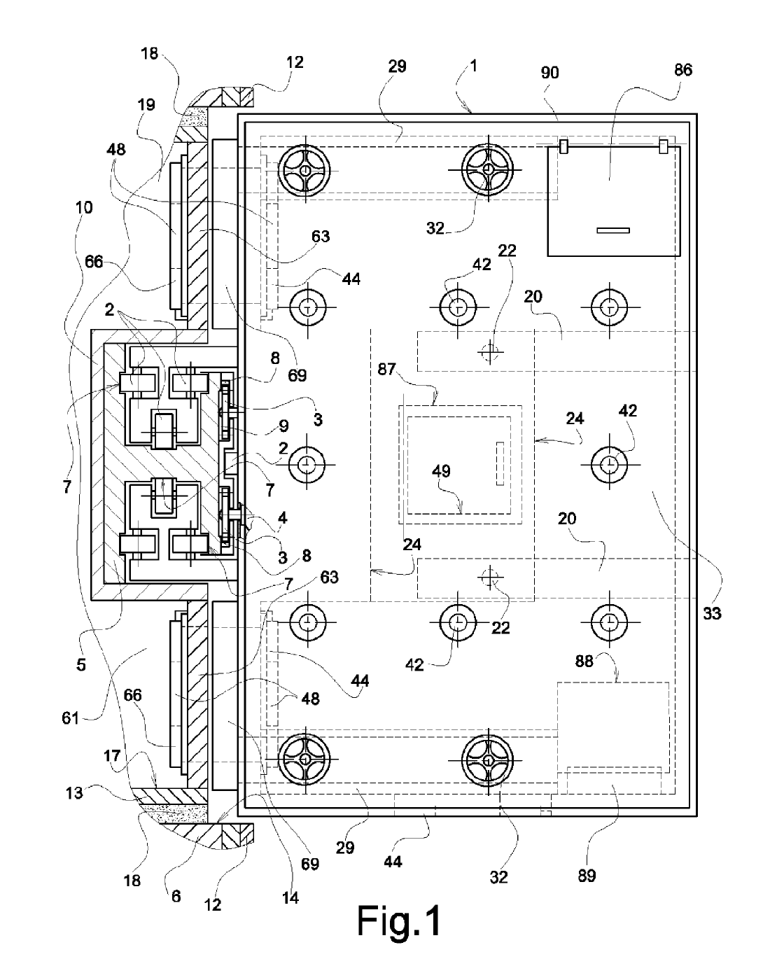

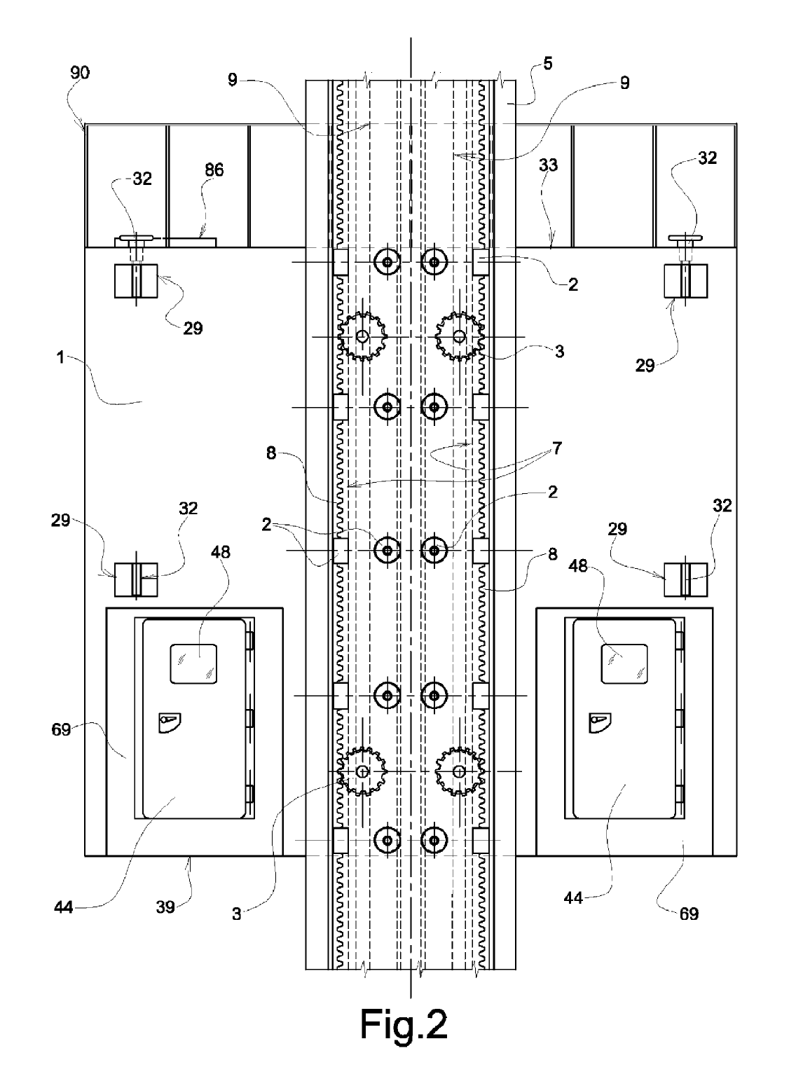

As it is seen on FIG. 1 and FIG. 2, the hoisting units in a form of hoisting tackles 1 have running gears completely similar to each other, with support wheels 2 and drive cog-wheels 3. Drive cog-wheels 3 are driven by driving unit 4, mounted inside bodies of hoisting tackles 1. With use of their running gears, hoisting tackles 1 can move along H-shaped rail 5 mounted on outer surfaces of high-rise building 6. The opportunity is enabled due to interplay of support wheels 2 and drive cog-wheels 3 with guide grooves 7 or rack guides 8, respectively, of H-shaped rail 5 (FIGS. 1 and 2).

In order to strengthen such interplay, support wheels 2 are installed in different planes while drive cog-wheels 3 are put in guide grooves 9 of H-shaped rail 5.

Building 6 can have several lines of H-shaped rail 5 on its outer surfaces, which is permanently installed along the entire height of the project in metal casings 10 so that rail 5 never drops out the external dimensions of the building.

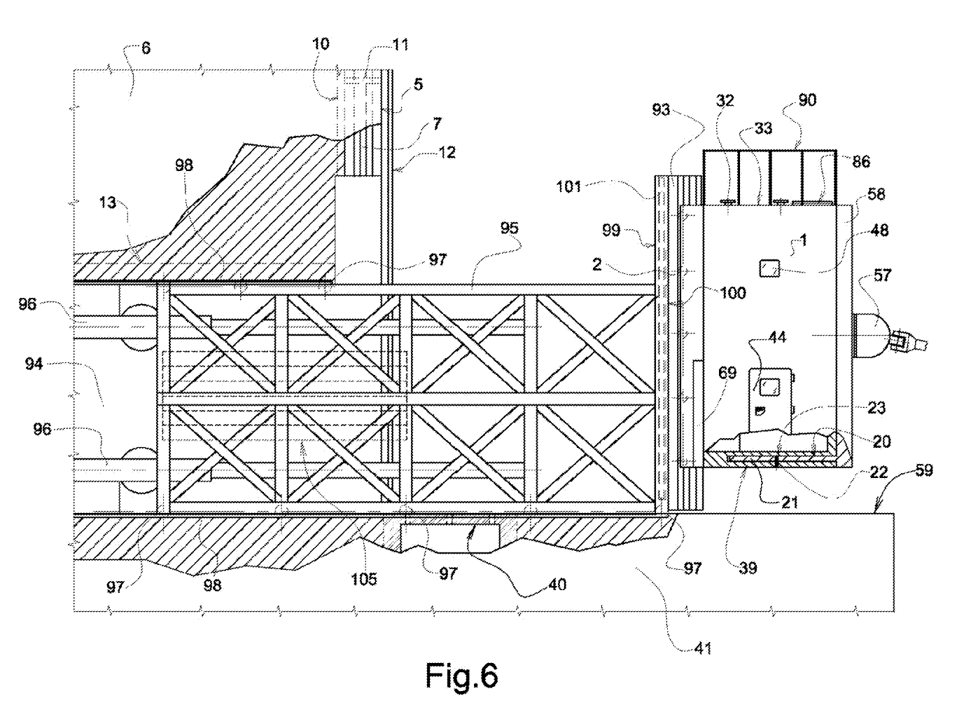

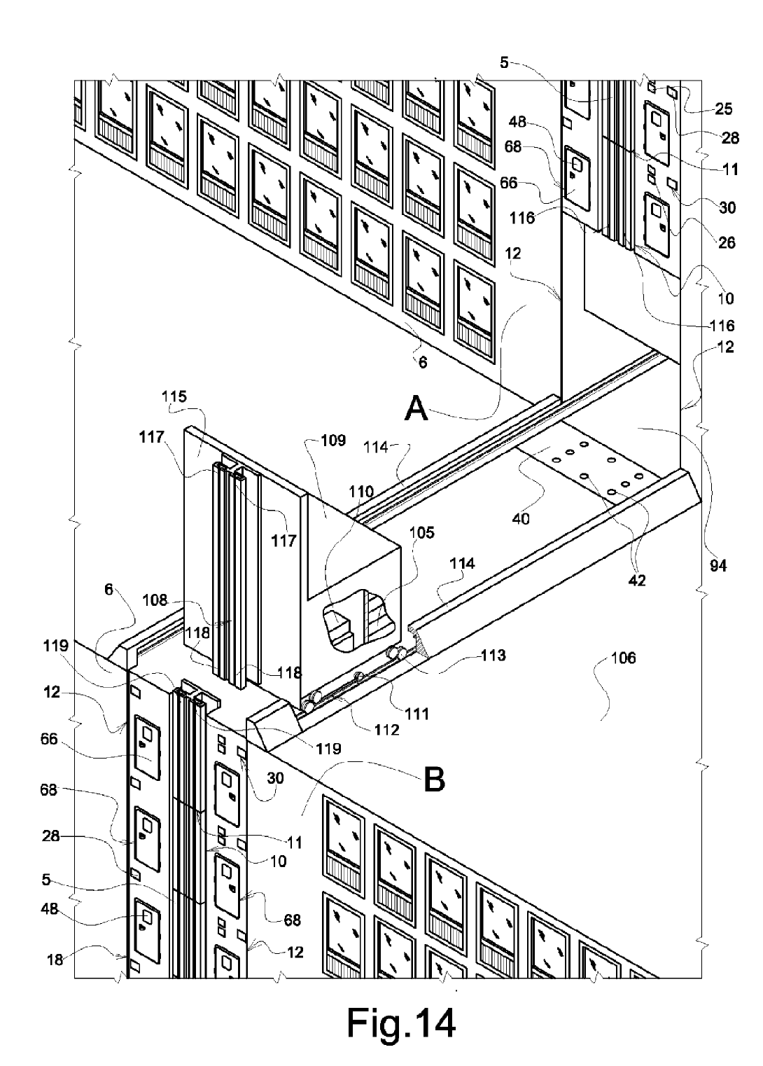

In order to prevent deformation of H-shaped rail 5 under high-temperature exposure (for example, during conflagration), temperature-resistant sections 11 are set into its metal casing, at equal intervals, which are made of refractory and heat-resistant material (for instance, of asbestos polymeric material) (FIGS. 6 and 14).

To enable visual control of entire length of H-shaped rail 5 at night time, its outer front surface can be supplied with illuminating fixtures.

To protect H-shaped rail 5 from adverse exposure to weather factors (rain and melted water, snow and ice), an in-built heating elements is set into its metal body that is connected to the stand-alone power-supply mains. To protect H-shaped rail 5 from adverse exposure to weather factors (rain and melted water, snow and ice), as well as to retain architectural integrity of the building, wall embrasure of the zone of location of H-shaped rail 5 is equipped with expandable wall panels 12 (FIG. 1).

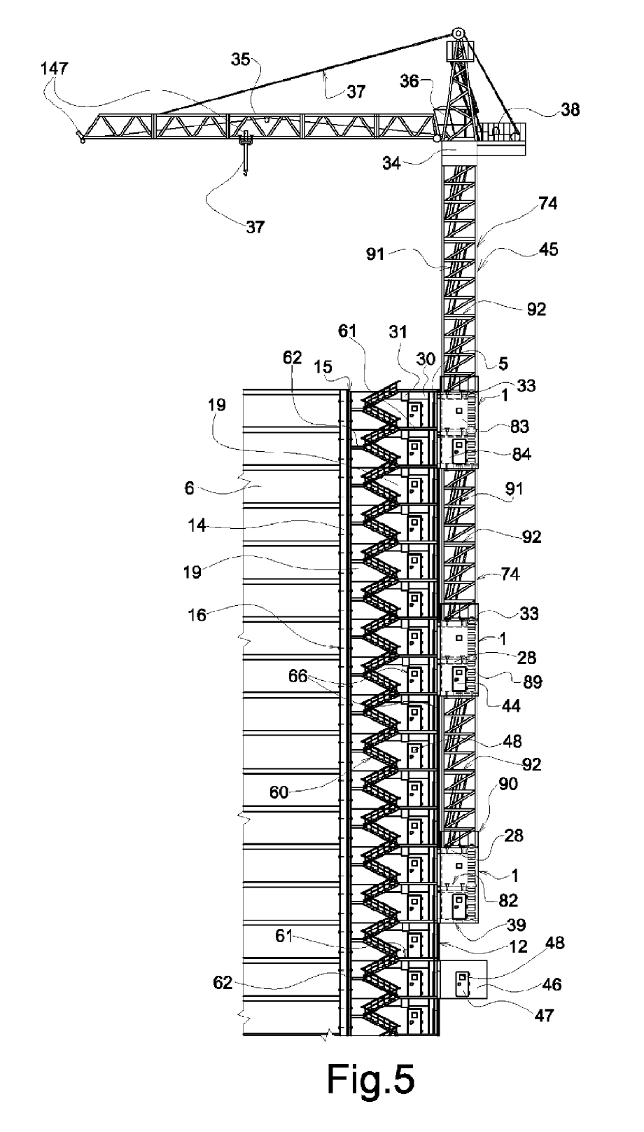

Each individual hoisting tackle 1 can simultaneously operate at a single vertical line of H-shaped rail 5 with other similar hoisting tackles 1 and, at the same time, interact with them for purpose of completing a specific task, for instance, for construction of a high-rise building acting as a vertically self-relocating lifting tower crane (FIG. 5).

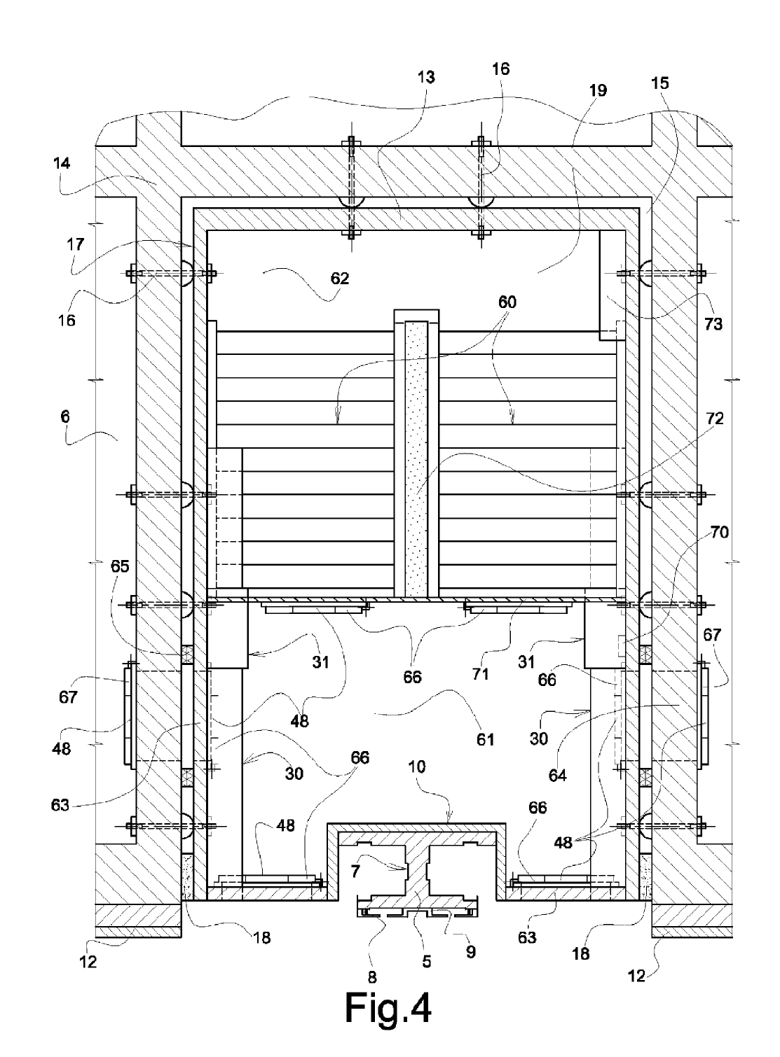

In order to ensure minimization of physical loads on the structure of building 6 during motion on H-shaped rail 5 of hoisting tackles 1, H-shaped rail 5 is rigidly fixed on metal load-bearing skeleton 13 that forms a vertical structure of a tower type. The structure has no rigid connection with bearing elements 14 of building 6 and be located both inside the perimeter of building 6 in its vertical clearance 15 (FIG. 4), and outside the perimeter of building 6.

In order to minimize transmission of vibration on the structure of building 6 during motion on H-shaped rail 5 of hoisting tackles 1, metal load-bearing skeleton 13 can have non-rigid connection with bearing elements 14 of building 6 via damping buckles 16 (FIG. 4).

In order to ensure sound insulation for the rooms in building 6 that abut with the area of installation of H-shaped rail 5, such rail will be fastened to load-bearing skeleton 13 via metal sheath 10.

Besides metal load-bearing skeleton 13 has (as an option) walls along its entire outer perimeter. In order to provide the rooms in building 6 that abut with the area of installation of H-shaped rail 5 with thermal impact protection (in case of fire), a free clearance is provided between load-bearing skeleton 13 and walls of building 6 which acts as an air cushion. Besides, walls of metal load-bearing skeleton 13 have hermetic temperature-resistant coating 17 (FIG. 4).

In order to protect the vertical tower-type structure and the walls of building 6 from weather factors' exposure, outer circuit of the spacing between walls of metal load-bearing skeleton 13 and building 6 is closed with hermetic elastic profile 18, which is made of heat-resistant material (FIG. 4).

In order to enable using rooms which inside building 6 abut to area of installation of H-shaped rail 5, as autonomous functional rooms for safe sheltering and evacuation of people (for instance, in case of fire), metal load-bearing skeleton 13 is divided (as an option) into autonomous sections (floors) 19 (FIG. 5).

The running gear of hoisting tackle 1 is equipped with driving device 4, which sets in motion drive cog-wheels 3, as well as other assemblies and aggregates of hoisting tackle 1. The driving unit represents either an internal-combustion engine or an electric motor. Power supply source is own petrol tanks or batteries, as well as from stand-alone power cables or contact rails. In addition to drive cog-wheels 3, the running gear of hoisting tackle 1 is equipped with several lines of support wheels 2. The support wheel 2 lines are located alternately perpendicularly in respect to each other (FIG. 1, 2).

In order to enable using hoisting tackle 1 in handling operations, its body's bottom part is provided with longitudinal grooves 20 for forked elements 21 with screw-jack stoppers 22, which contact with openings 23 of these forked elements 21 (FIG. 6).

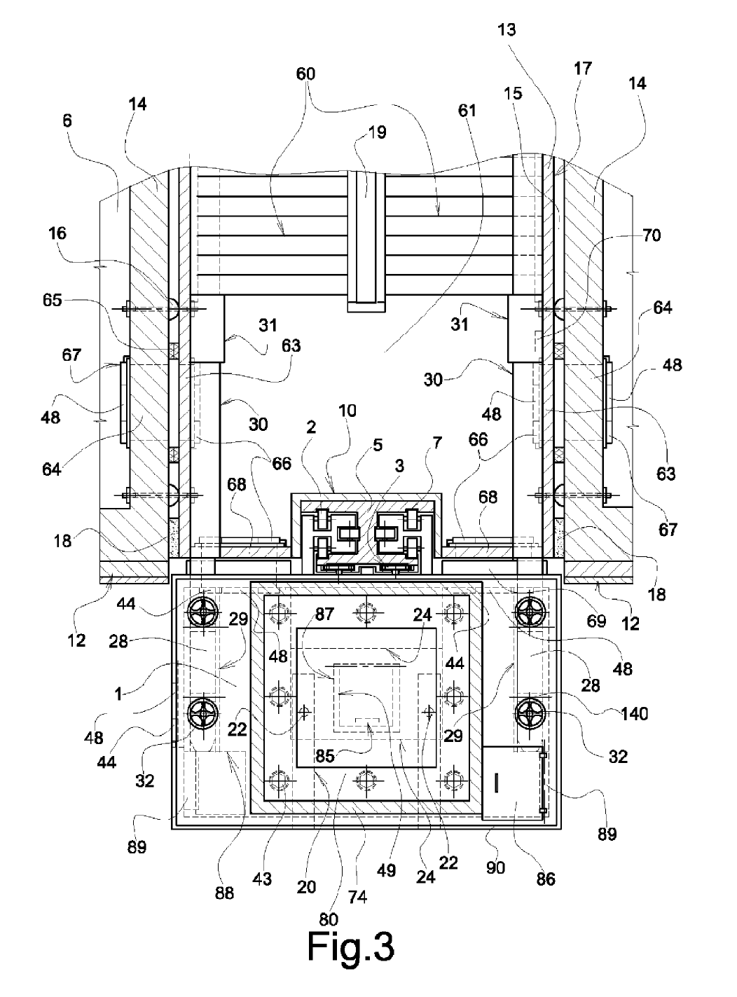

In order to ensure continuous refueling of driving unit 4 of hoisting tackle 1, tanks to store fuel and other process liquids are provided in compartment 24 of driving unit 4. There also terminals to connect pipelines and power cables, and compartments to store auxiliary equipment (FIGS. 1 and 3).

In order to enable connecting of any individual hoisting tackle 1 to autonomous facilities (power mains and pipelines) at any level of the high-rise project, autonomous mains and pipelines are laid in immediate vicinity of the line of H-shaped rail 5 and along its heights in the walls of building 6. The facilities are provided at each level of building 6 with terminals 25 to connect power cables and terminals 26 to connect pipelines (hoses and pipes). Hoisting tackle 1 is connected to the terminals with use of similar terminals located at its outer surfaces and terminals located in its internal compartment.

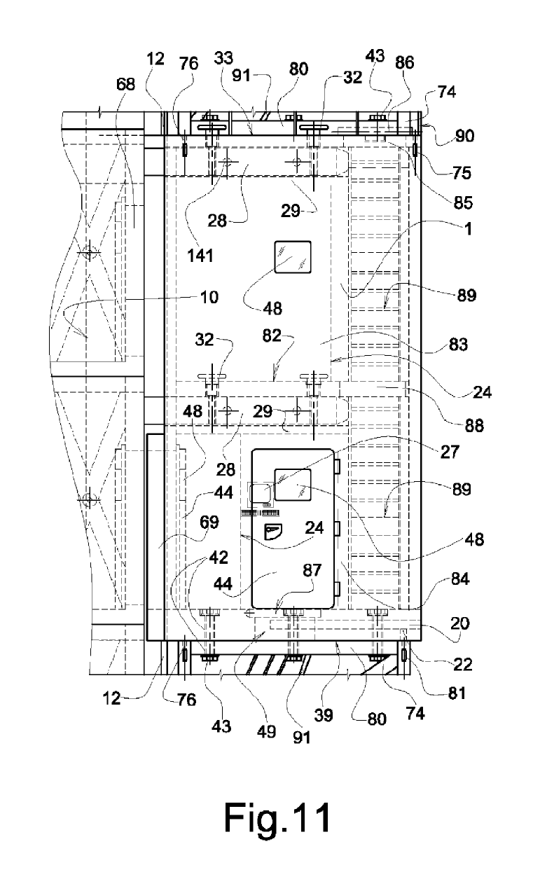

Each individual hoisting tackle 1 can be operated by personnel both from inside with use of control panel 27 (FIG. 11), and from outside with use of a remote control panel.

To illuminate hoisting tackle 1 and the surrounding area of its operation at night time, searchlights are provided on its body's external surfaces.

In order to enable rigid connection of hoisting tackle 1 with the structure of building 6, which is required in order to increase stability and carrying capacity of hoisting tackle 1, autonomous section (floor) 19 is equipped with supporting elements 28, which contact with take-up casings 29 of hoisting tackle 1 (FIG. 3).

In order to enable temporary rigid connection of hoisting tackle 1 with the structure of building 6, which is required in order to increase stability and carrying capacity of hoisting tackle 1 at the moment of such connection, supporting elements 28 are located in guiding casings 30 of autonomous section (floor) 19 and are extended into take-up casings 29 of hoisting tackle 1 (and backward) either manually or (as an option) with use of screw-jack devices 31. After maximal moving of supporting elements 28 inside hoisting tackle 1, these supporting elements 28 are fixed with stoppers 32 (FIG. 3).

In order to enable temporary rigid connection of hoisting tackle 1 with the structure of building 6 at any area of the vertical line of H-shaped rail 5, which is required in order to increase stability and carrying capacity of hoisting tackle 1 at the moment of such connection, guiding casings 30 together with supporting elements 28 inside them are provided at every level (floor) of building 6, along entire vertical line of H-shaped rail 5 (FIG. 5).

In order to enable using of hoisting tackle 1 as a lifting tower crane, on upper horizontal surface 33 of hoisting tackle 1, a vertical truss of the tower-type is installed. On the top end of the truss, there are turntable 34, outrigger 35, operator's cabin 36, hauling gear (ropes) 37 and lifting mechanisms (winches) 38, installed (FIG. 5).

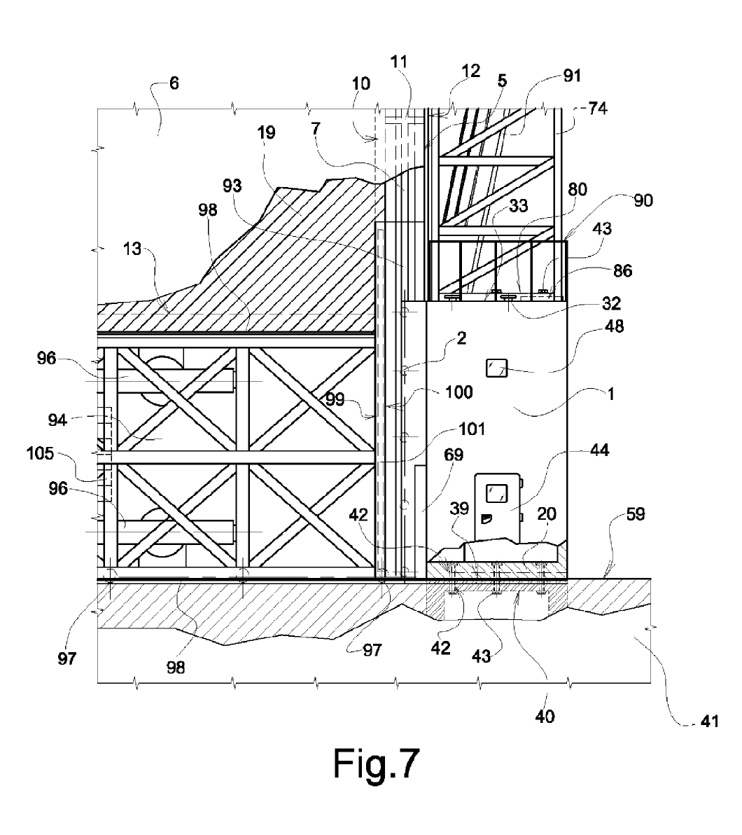

In order to ensure minimal physical loads on H-shaped rail 5 during use of hoisting tackle 1 as a lifting tower crane fixed on a horizontal surface, the self-propelled structure is rigidly fastened on the horizontal surface, on which hoisting tackle 1 is installed. Fixing is performed by means of connecting bottom horizontal surface 39 of this hoisting tackle 1 with metal insert 40, made, as an option, within concrete foundation 41 of building 6, through openings 42, for instance, with screw couplings 43 (FIG. 7).

In order to ensure minimal physical loads on H-shaped rail 5 during use of hoisting tackle 1 as a lifting tower crane with vertical self-relocation, the self-propelled structure comprises at least two hoisting tackles 1. The blocks are rigidly connected between them with use of additional vertical tower-type truss 45 (FIG. 5).

In order to ensure safety during passage of people from hoisting tackle 1 to the ground and back, a mobile ladder is used which contacts during such operation with hermetically-closed doors 44 of hoisting tackle 1.

Hoisting tackle 1 has solid hermetic heat-resistant outer coating, internal illumination, an air cleansing and conditioning system, oxygen masks, a first-aid kit to render emergency medical aid, as well as fire-fighting and other process equipment (depending on its equipment type).

Hoisting tackle 1 is equipped with various auxiliary equipment (a video camera, a loud speaker, a voice intercom unit, sensors to determine temperature, distance, wind loads, air pollution etc.).

In order to ensure safety during emergency lowering of hoisting tackle 1 from a high-rise project on H-shaped rail 5, drive cog-wheels 3 are equipped with a mechanical inversion brake system (similar to a known railway car retarder used in spacing braking). The brake system will enable smooth rotation of cog-wheels 3 at a certain constant speed in event of the emergency lowering.

In order to enable emergency brake application of hoisting tackle 1, drive cog-wheels 3 are equipped with mechanical drum brake system (similar to a know car drum brakes). The brake system is connected with metal line with levers located on control panels 27.

Additional hoisting tackle 46 can simultaneously operate on a single line of H-shaped rail 5 with other hoisting tackles 1 and, at the same time, interplay with them completing a specific task related to, by way of instance, lifting or lowering people and tools to a lifting tower crane with vertical self-relocation (FIG. 5, 8).

Additional hoisting tackle 46 represents a cargo-and-passenger cage of a rectangular form with own running gear.

The running gear of additional hoisting tackle 46 is designed similarly to the running gear of hoisting tackle 1.

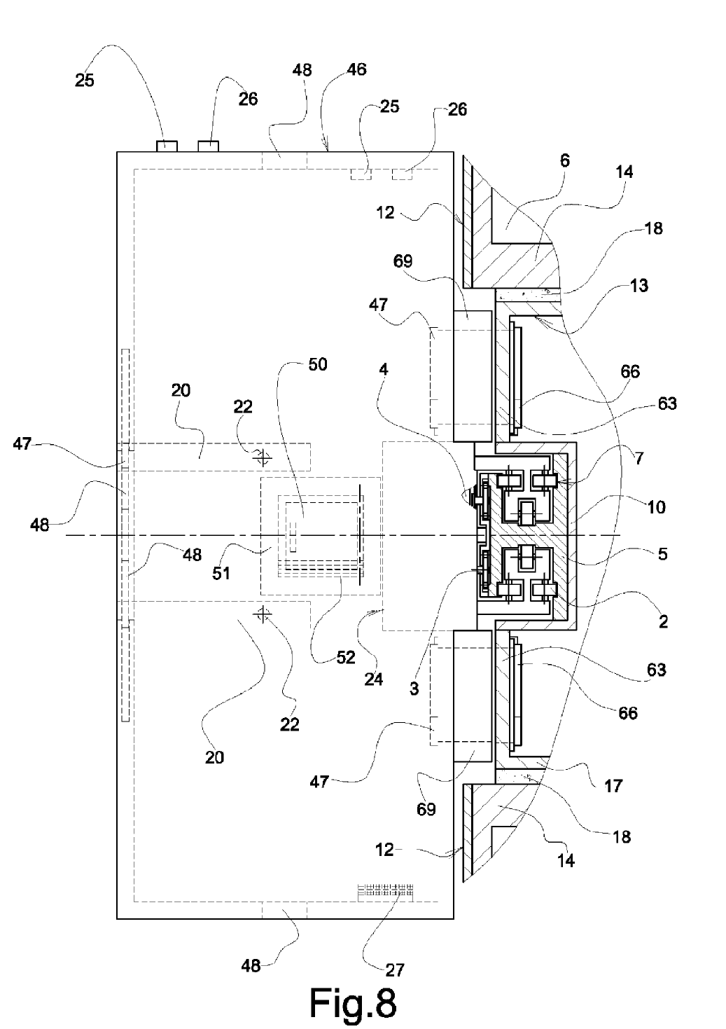

Additional hoisting tackle 46 is equipped with hermetically-closed doors 47 with heat-resistant windows 48. Besides, in order to communicate with aperture 49 of hoisting tackle 1, additional hoisting tackle 46 has in its upper surface, hatch 50, along perimeter of which hatch elastic profile 51 is provided. Inside the cage of additional hoisting tackle 46 a telescope ladder 52 is attached to hatch 50 (FIG. 8).

In order to enable using additional hoisting tackle 46 in loading/unloading operations, its body's bottom part is provided with longitudinal grooves 20 for forked elements 21 with screw-jack stoppers 22, which contact with openings 23 of these forked elements 21.

In order to ensure continuous refueling of additional hoisting tackle 46 with power and fuel, terminals 25 and terminals 26 are provided in its cabin to connect power cables and pipelines respectively, which contact with similar terminals located at each level of building 6 (FIG. 8).

Control panel 27 is provided inside the cabin of additional hoisting tackle 46. Additional hoisting tackle 46 can be thus controlled by personnel both from inside, and outside using a remote control panel.

To enable vision from inside of additional hoisting tackle 46 of all adjacent area of its operation, heat resistant windows 48 are provided on external surfaces of its body as well as on all of its doors (FIG. 8).

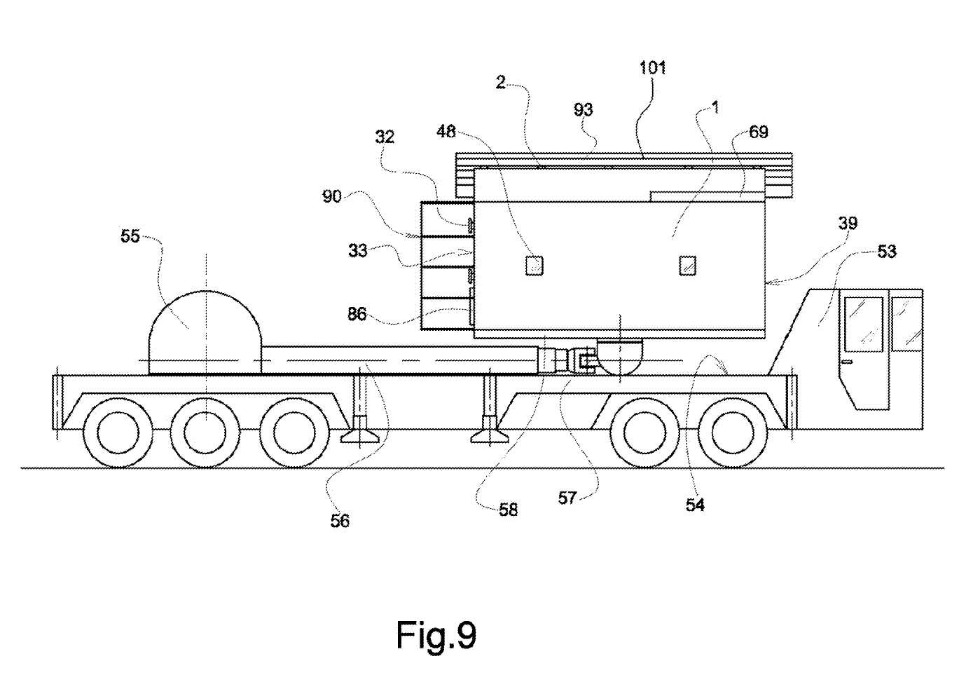

Self-propelled chassis 53 is designed to enable transportation of hoisting tackles 1 and additional hoisting tackles 46 from storage facilities to the high-rise constructions to be serviced (FIG. 9).

Besides, one of functionalities of self-propelled chassis 53 is its capacity to load/unload such hoists on/from H-shaped rail of a high-rise building serviced.

Self-propelled chassis 53 represents a truck with a rather large area of the operating surface of its body (54). Telescopic boom 56 is movably installed on swivel gear 55, at the operating surface of body 54.

The end of telescopic boom 56 is equipped with swivel gear 57, on which support 58 is installed, with forked elements 21 which contain openings 23 (FIGS. 6 and 9).

In order to enable continuous and free access of self-propelled chassis 53 to H-shaped rail 5 of the high-rise building serviced, there is a concrete parking slot in the area of the lower ending of the rail.

In order to enable continuous and free access of personnel to H-shaped rail 5 of the high-rise building serviced, there is auxiliary portal 59 of building 6 provided in the area of the lower ending of the rail.

To protect the concrete parking slot and auxiliary portal 59 from adverse impacts of weather factors (rain and melted water, snow and ice), in-built heating elements are provided in the concrete foundations of the parking slot and auxiliary portal 59 that are connected with a stand-alone power mains. To ensure water draining, sewage wells with grids are provided in the concrete parking slot.

In order to enable people's access to every autonomous section (floor) 19, sections (floors) 19 are connected to each other with stairways 60, as well as evacuation inter-stairway grounds 61 and intermediate stairway grounds 62 (FIG. 5).

To ensure communication of each autonomous section (floor) 19 with parallel floors of building 6, doorways 63 are envisaged in the walls of metal load-bearing skeleton 13 in the zone of location of grounds 61 of each autonomous section (floor) 19. Doorways 64 are provided opposite doorways 63, in the walls of building 6 (FIGS. 3 and 4).

For purpose of ensuring safety during passing of people through doorways 63 and 64, hermetic elastic profile 65 is laid along perimeters of connection of doorways 63 and 64 (FIGS. 3 and 4).

In order to protect autonomous sections (floors) 19 against adverse exposures (such as thermal impact or carbon monoxide during fire), doorways 63 and 64 are equipped with hermetically-closed doors 66 and 67, made of a heat-resistant material (FIGS. 3 and 4).

In order to enable visual control over the area adjacent to doors 66 and 67, doors 66 and 67 are provided with heat-resistant windows 48 (FIGS. 3 and 4).

In order to ensure communication between each autonomous section (floor) 19 with internal compartments that are parallel to hoisting tackles 1, exists 68 are provided in walls of metal load-bearing skeleton 13, on outside of which H-shaped rail 5 goes, in the area of location of evacuation inter-stairway grounds 61 of autonomous sections 19. Evacuation exits 63 get in contact with tambours 69 of hoisting tackle 1 (FIG. 1).

In order to protect autonomous sections (floors) 19 and the internal compartments of hoisting tackles 1 against adverse exposures (such as thermal impact or carbon monoxide during fire), evacuation exits 68 are equipped with hermetically-closed doors 66 made of heat-resistant material (FIGS. 3 and 4). To enable visual control over the area adjacent to doors 66, doors 66 are equipped with heat-resistant windows 48 (FIGS. 3 and 4).

In order to provide victims with the opportunity to call up evacuation hoisting tackle 1 and talk to rescue services, each evacuation inter-stairway ground 61 of autonomous sections (floors) 19 is equipped with telephone point 70 (FIG. 4).

In order to protect autonomous sections (floors) 19 against adverse exposures (such as thermal impact or carbon monoxide during fire), autonomous sections (floors) 19 are isolated (for instance, every three floors) with hermetic heat-resistant wall partitions 71 and inter-stairway walls 72 (FIG. 4).

To enable communication areas of autonomous sections 19 isolated between them with partitions 71 and walls 72, wall partitions 71 are provided with hermetically closed doors 66 (FIG. 4).

To enable visual control over the area adjacent to doors 66, doors 66 are equipped with heat-resistant windows 48.

In order to provide the victims' needs (for instance, during fire), each area of autonomous sections (floors) 19 has compartment 73 to store medicines, gas-masks, water, foodstuff (FIG. 4).

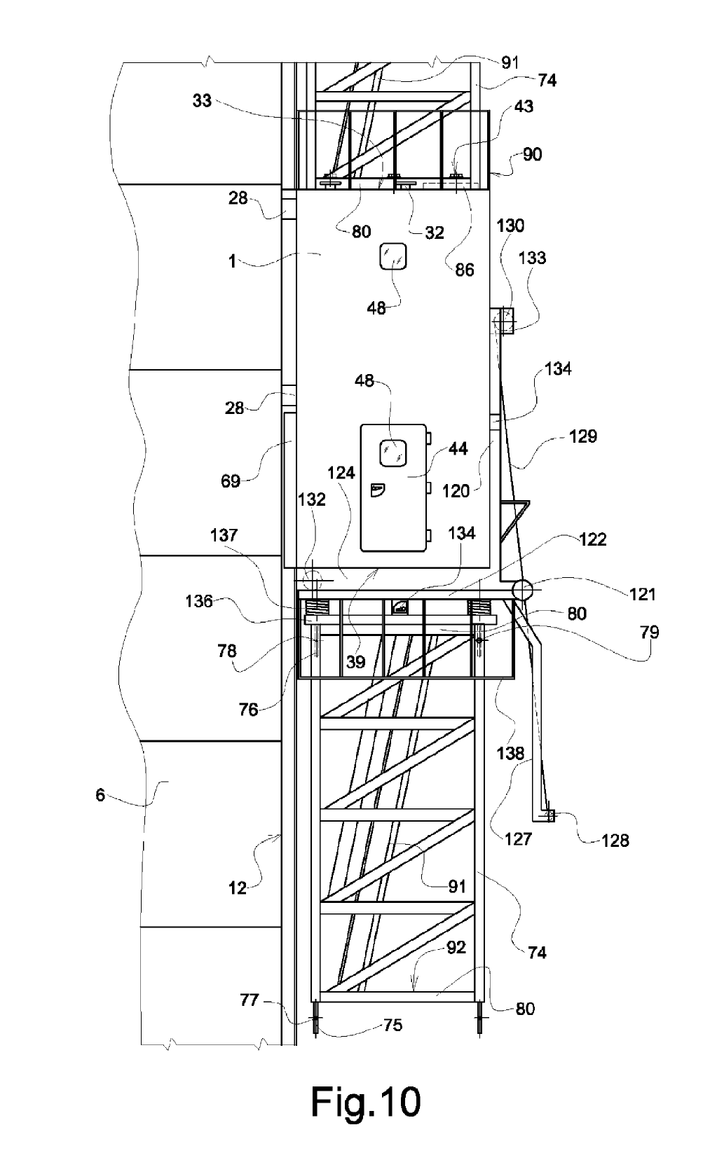

In order to enable mounting/dismantling of additional vertical tower-type trusses 45 on upper horizontal surface 33 and 39 of hoisting tackle 1, the trusses consist of collapsible sections 74, which can be assembled together with use of pins 75, dowels 76, openings 77 and 78, and screw couplings 79. Hoisting tackle 1 has on its outside horizontal surfaces 33 and 39 mounting pads. The pads are contacting mounting frames 80 of sections 74 of vertical tower-type trusses 45 through, say, screw couplings 43 (FIG. 10).

In order to enable precise positioning sections 74 of vertical tower-type trusses 45 in process of their mounting on outer horizontal surfaces of hoisting tackle 1, there are grooves 76 on its upper horizontal surface 33, which contact with mounting pins 75 of section 74. In their turn, there are removable mounting pins 81 on lower horizontal surface 39 of hoisting tackle 1, which contact with grooves 76 of section 74 (FIG. 11).

To ensure access of personnel to outer horizontal surfaces of hoisting tackle 1, there is a functional cabins inside hoisting tackle 1 (an internal compartment), divided (as an option) by inter-level ground 82 into internal levels (upper level 83 and lower level 84). Upper internal level 83 communicates with the mounting pad of upper horizontal surface 33 through aperture 85 and hatch 86. Lower internal level 84 communicates with the mounting pad of lower horizontal surface 39 through aperture 49 and hatch 87 (FIG. 11).

In order to provide communication between internal levels 83 and 84 of the internal compartment of hoisting tackle 1, levels 83 and 84 are connected via aperture 88 of inter-level ground 82 with ladder 89 (FIG. 11).

In order to ensure communication between the internal compartment of hoisting tackle 1 and autonomous section (floor) 19, the upper surface of hoisting tackle 1, which mates with building 6, is equipped with tambours 69, that are in contact with evacuation exits 68 of building 6 (FIG. 11). To ensure protection of the internal compartment of hoisting tackle 1 against adverse exposures (such as thermal impact or carbon monoxide during fire), tambours 69 of hoisting tackle 1 are equipped with hermetically-closed doors 44 made of heat-resistant material (FIG. 11). To ensure communication between the internal compartment of hoisting tackle 1 and the outside, for instance, when hoisting tackle 1 is on the first floor of building 6, its side surface that does not mate with the wall of the building, is provided with additional hermetically-closed door 44 (FIG. 11). To enable visual control over, hermetically-closed doors 44 are equipped with heat-resistant windows 48. To ensure safety for personnel, the mounting pad on upper horizontal surface 33 of hoisting tackle 1 has the dimensions of its area sufficient to allocate lower mounting frame 80 of section 74 of vertical tower-type truss 45 and several riggers. Besides, the mounting pad is equipped along its perimeter with fence 90 (FIGS. 5 and 10). Screw couplings 43 can be accessed by personnel both from the outer mounting pad of upper horizontal surface 33, and from the internal compartment of hoisting tackle 1 (FIG. 11). To ensure safety for personnel, every section 74 of vertical tower-type truss 45 is equipped with ladders 91 and passage pads 92 (FIGS. 5 and 11), which communicate with the internal compartment of hoisting tackle 1 via its aperture 49 and hatch 87 (FIG. 11).

In order to enable using hoisting tackle 1 as a lifting tower crane, self-mounted in its lower part, the lower part of building 6 is equipped with a docking device. The docking device enables completing fully-mechanized (without manual operations) installation of H-shaped rail removable section 93 (with or without hoisting tackle 1) on a wall of a high-rise construction (FIG. 6).

The docking device represents functional compartment 94 of building 6, in which pullout frame 95 connected with screw-jack devices 96 is installed. With use of screw-jack devices 96, pullout frame 95 can move beyond the outside limits of building 6 and back (FIG. 6).

Reliability and smoothness of the motion is enabled for pullout frame 95 by its support wheels 97, which are in contact with guides 98 provided in the surfaces of functional compartment 94 (FIG. 6).

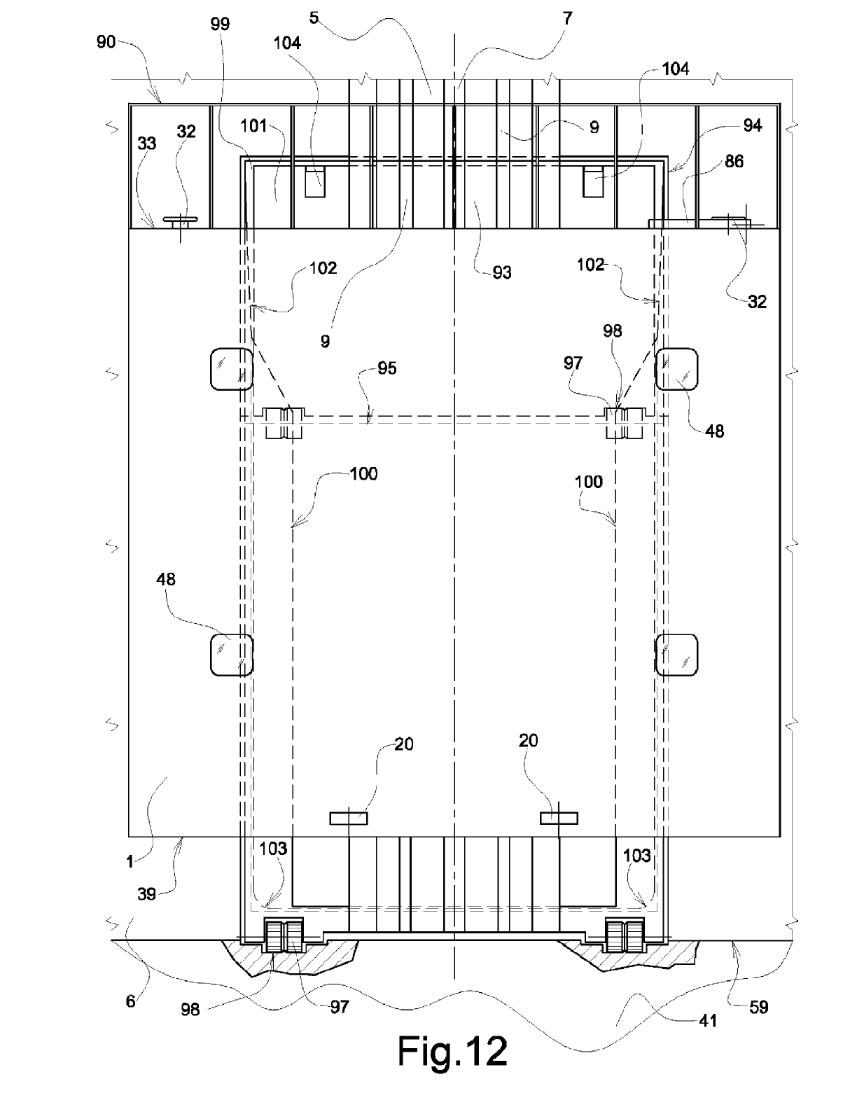

Pullout frame 95 has in its frontal part, take-up panel 99 with overlay guides 100 provided on its right- and left-hand sides (FIG. 12).

In order to ensure its connection with take-up panel 99, H-shaped rail removable section 93 is equipped with mounting panel 101, which design is similar to a rectangular design of take-up panel 99. Thickness of mounting panel 101 is slightly less than the clearance is between overlay guides 100 and outer surface of take-up panel 99, which enables them to get connected (FIG. 6).

In order to ensure safety during such connection, take-up panel 99 is equipped with chamfered guiding stands 102, while mounting panel 101 is equipped with bottom rounded corners 103 (FIG. 12).

In order to enable mounting of an H-shaped rail's removable section 93 (without hoisting tackle 1) with use of any crane device, the upper part of mounting panel 101 is provided with grooves 104 used to hook with hooks of a crane device (FIG. 12).

In order to ensure safety during mounting/dismantling of the H-shaped rail's removable section 93, the bottom part of functional compartment 94 of building 6 is arranged with concrete foundation 41 (FIGS. 6 and 12).

In order to minimize physical loads on pullout frame 95 during mounting on hoisting tackle 1 (at its position on this frame 95) of functional elements of the lifting tower crane, pullout frame 95 can be equipped inside with counterbalance 105, made of ferroconcrete blocks (FIG. 6).

In order to enable protection of functional compartment 94 of building 6 from adverse exposures of weather factors and retain architectural integrity of the building, outer aperture of functional compartment 94 of building 6 is provided with expandable wall panels 12 (FIG. 6).

In order to enable overcoming by hoisting tackles 1 of horizontal cornices up to 3 meter wide during operation on building 6 that has projection design of its outer surfaces, transfer junctions are provided on the cornices of such building. A transfer junction of building 6 designed for hoisting tackles 1 to overcome cornices up to 3 meters wide represents functional compartment 94 of building 6, where pullout frame 95 is installed, connected with screw-jack devices 96.

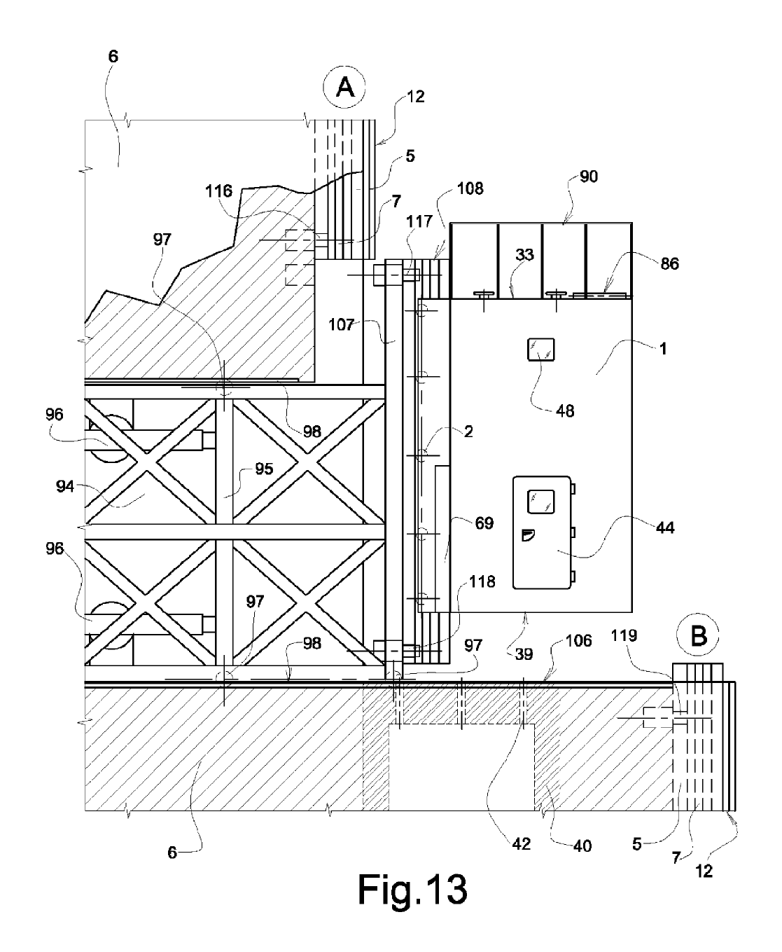

Using screw-jack devices 96, pullout frame 95 can move from functional compartment 94 outside the outer limits of a surface of building 6 and back (FIG. 13).

Reliability and smoothness of the motion is enabled for pullout frame 95 by its support wheels 97, which are in contact with guides 98 provided on an outer surface of cornice 106 and in the upper part of functional compartment 94.

Pullout frame 95 in its frontal part is provided with outer panel 107 with mobile section 108 of H-shaped rail 5 provided on it.

As long as building 6 has projection structure design of its outer surfaces, its two outer surfaces (A and B) with two vertical lines of H-shaped rails 5 are separated by horizontal cornice 106. Accordingly, outer surface A located over cornice 106 is closer to the axis of symmetry of the high-rise building, and outer surface B located below cornice 106 is farther from the axis and represents a projection of building 6. Therefore, when pullout frame 95 is maximally moved into functional compartment 94 of building 6, mobile section 108 of H-shaped rail 5 is integral with H-shaped rail 5 mounted on outer surface A of building 6. On the other hand, as pullout frame 95 is maximally extended out from functional compartment 94, mobile section 108 of H-shaped rail 5 is integral with H-shaped rail 5 mounted on outer surface B of building 6.

In order to enable overcoming by hoisting tackles 1 of horizontal cornices over 3 meter wide during operation on building 6 that has the projection (stepped) design of its outer surfaces, transfer junctions are provided on the cornices of such a building. A transfer junction of building 6 designed for hoisting tackles 1 to overcome cornices over 3 meters wide represents functional compartment 94 of building 6, where self-propelled module 109 is installed, which is equipped with driving unit 110 (FIG. 14). Driving unit 110 puts in motion drive cog-wheels 111. Using such drive cog-wheels 111 and rack guides 112 contacting the wheels, self-propelled module 109 can move out from functional compartment 94 beyond the outer limits of the surface of building 6 and back. Reliability and smoothness of the motion of self-propelled module 109 is enabled by its support wheels 113, which contact with guides 114 made on outer surface of cornice 106 of building 6 (FIG. 14). Self-propelled module 109 in its frontal part has outer panel 115 with section 108 of H-shaped rail 5 installed on it.

As long as building 6 has the stepped (projection) design of its outer surfaces, its two outer surfaces (A and B) with two vertical lines of H-shaped rails 5 are separated by horizontal cornice 106. Accordingly, outer surface A located over cornice 106 is closer to the axis of symmetry of the high-rise building, and outer surface B located below cornice 106 is farther from the axis and represents a projection of building 6. Therefore, when self-propelled module 109 is maximally moved into functional compartment 94 of building 6, section 108 of H-shaped rail 5 is continuous with H-shaped rail 5 installed on outer surface A of building 6. On the other hand, when self-propelled module 109 is maximally extended out from functional compartment 94, mobile section 108 of H-shaped rail 5 is continuous with H-shaped rail 5 installed on outer surface B of building 6.

In order to ensure safety during moving of hoisting tackles 1 from one H-shaped rail 5 to mobile section 108 of H-shaped rail 5 and back, as well as during transportation of hoisting tackles 1 on mobile section 108 of H-shaped rail 5 from one surface of a high-rise building to another and back, ends of H-shaped rail 5 and mobile section 108 of H-shaped rail 5 are provided with screw-jack stops 116, 117, 118, and 119 (FIGS. 13 and 14).

In order to minimize as much as possible physical loads on self-propelled module 109 during mounting/demounting on hoisting tackle 1 (as it is on self-propelled module 109) of functional parts of the lifting tower crane, counterweight 105 is inside self-propelled module 109, which is (as an option) made of ferroconcrete blocks (FIG. 14).

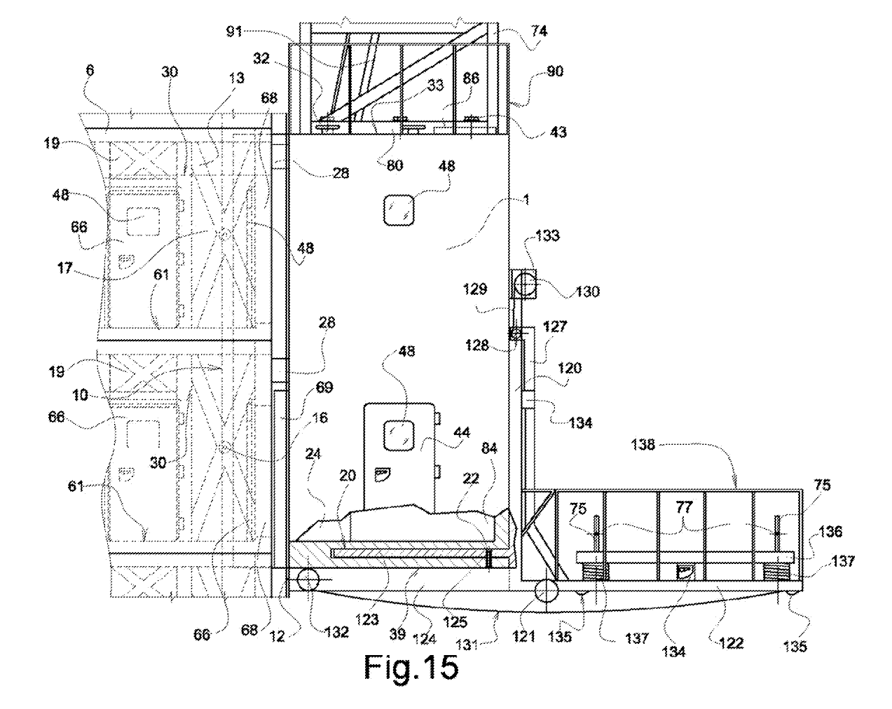

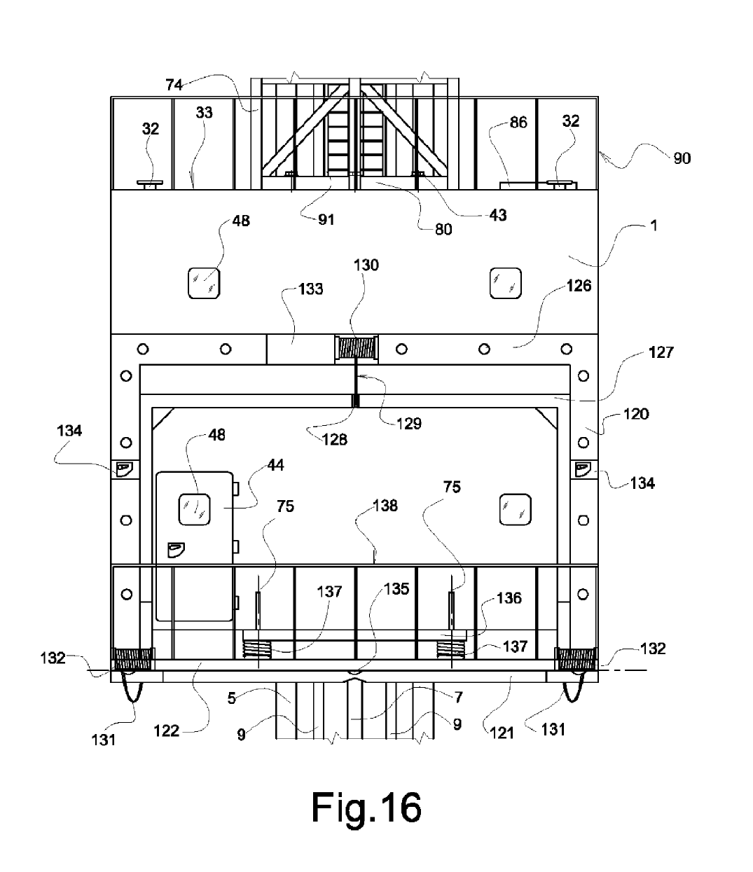

In order to enable using of hoisting tackle 1 as a lifting tower crane that is self-mounted in its upper part, removable frame 120 is provided on the upper surface of hoisting tackle 1, which is movably attached, via swivel connector assembly 121, to mounting swivel ground 122 (FIGS. 15 and 16). In order to enable mounting/demounting of removable frame 120 on outer surface of hoisting tackle 1, this frame 120 is equipped, by way of an instance, with forked elements 123, which contact with longitudinal grooves 20 of hoisting tackle 1. Removable frame 120 is also equipped with support shafts 124, which contact with lower horizontal surface 39 of hoisting tackle 1. In order to enable rigid connection of removable frame 120 on the outer surface of hoisting tackle 1, its forked elements 123 are fixed in longitudinal grooves 20 of hoisting tackle 1 by means of installation of screw-jack stoppers 22 in openings 125 of forked elements 123. Removable frame 120 is mounted on the outer surface of hoisting tackle 1 by means, for instance, of screw couplings 126 (FIGS. 15 and 16).

In order to enable mechanized rotation of mounting swivel ground 122 by 180° with regard to the symmetry axis of hoisting tackle 1, this mounting swivel ground 122 is equipped with turntable 127. Turntable 127 is movably attached, via swivel block 128, with a pull unit in a form of rope 129 of the hoisting gear, for instance, winch 130 located in the upper part of removable frame 120. Mounting swivel ground 122 itself is movably, via its lower surface, connected with pull ropes 131 of hoisting gears, for instance, winches 132, which are located in support shafts 124 (FIG. 15).

In order to broaden functionalities of winch 130, its electric motor 133 is also equipped in the upper part of removable frame 120 (FIG. 15). In order to provide mechanical fixation of turntable 127 on the upper surface of hoisting tackle 1, locking devices 125 are provided on removable frame 120 (FIG. 15). To ensure safety during rotation of mounting swivel ground 122 by 180° with regard to the symmetry axis of hoisting tackle 1, elastic elements 135 are provided on the lower surface of mounting swivel ground 122. In order to enable mounting or demounting of sections 74 of vertical tower-type truss 45 on mounting swivel ground 122, mounting pad 136 is provided on the upper surface of mounting swivel ground 122, which is equipped with mounting pins 75 that contact with grooves 76 of sections 74 (FIGS. 15 and 16).

In order to provide mechanical fixation of sections 74 of vertical tower-type truss 45 on mounting pad 136, mounting pins 75 are fixed in grooves 76 of sections 74 with use of openings 77 and 78, as well as screw couplings 79 (FIGS. 15 and 10). In order to provide safety during mounting operations over sections 74 of vertical tower-type truss 45, mounting pad 136 is fixed on mounting swivel ground 122 with use of shock-absorbing springs 137 and locking devices 134 (FIG. 15).

To ensure access by personnel from the internal compartment of hoisting tackle 1 to mounting swivel ground 122, hermetically-closed door 44 is provided on the outer surface of hoisting tackle 1, in the area of location of mounting swivel ground 122 (FIG. 16). In order to ensure safety for personnel located on mounting swivel ground 122, fencing 138 is provided along its perimeter (FIG. 16). In order to provide personnel with opportunity of visual control of outer space around hoisting tackle 1, heat-resistant windows 48 are provided in the body of hoisting tackle 1 as well as in its hermetically-closed door 44 (FIGS. 15 and 16).

To ensure rigid attachment of the tower crane formed by sections 74 and hoisting tackles 1, to the load bearing structure of building 6, sections 74 are equipped with mounting panels 139. Panels 139 are rigidly fixed to supporting elements 28 with use of grooves 140, horizontal openings 141 in supporting elements 28 and latches 32 (FIG. 11, 17 [symbol] 18).

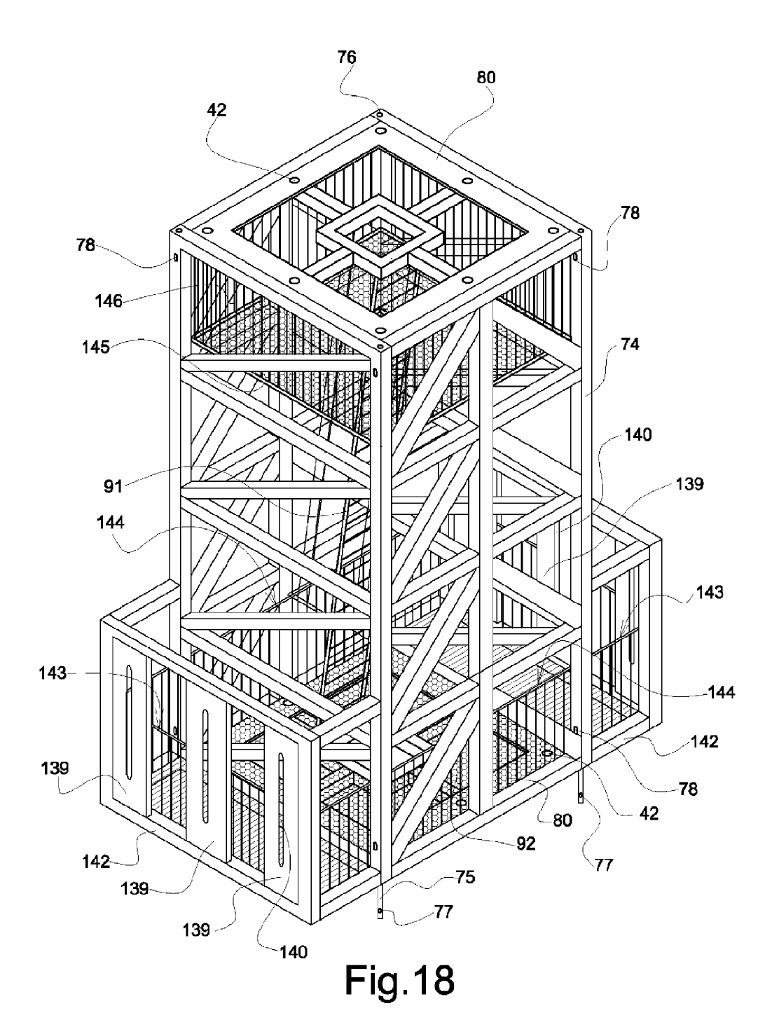

In order to ensure broadening of its functionalities, sections 74 of vertical tower-type truss 45 are equipped with mounting balconies 142 integral with the load-bearing skeleton of such section 74 (FIG. 18).

In order to ensure safety for personnel, mounting balconies 142 and transfer grounds 92 are provided with fences 143 and 144 respectively (FIG. 18). In order to ensure safety of personnel during their operation related to attachment of sections 74 of vertical tower-type truss 45 to one another, each such section 74 is equipped in its upper part with mounting pad 145 which is provided with fence 146 along its perimeter. In order to enable broadening of functionalities of a tower crane, its structural components are equipped with video cameras 147 that transmit pictures to monitors located in operator's cabin 36 and on the remote control panel (FIG. 5).

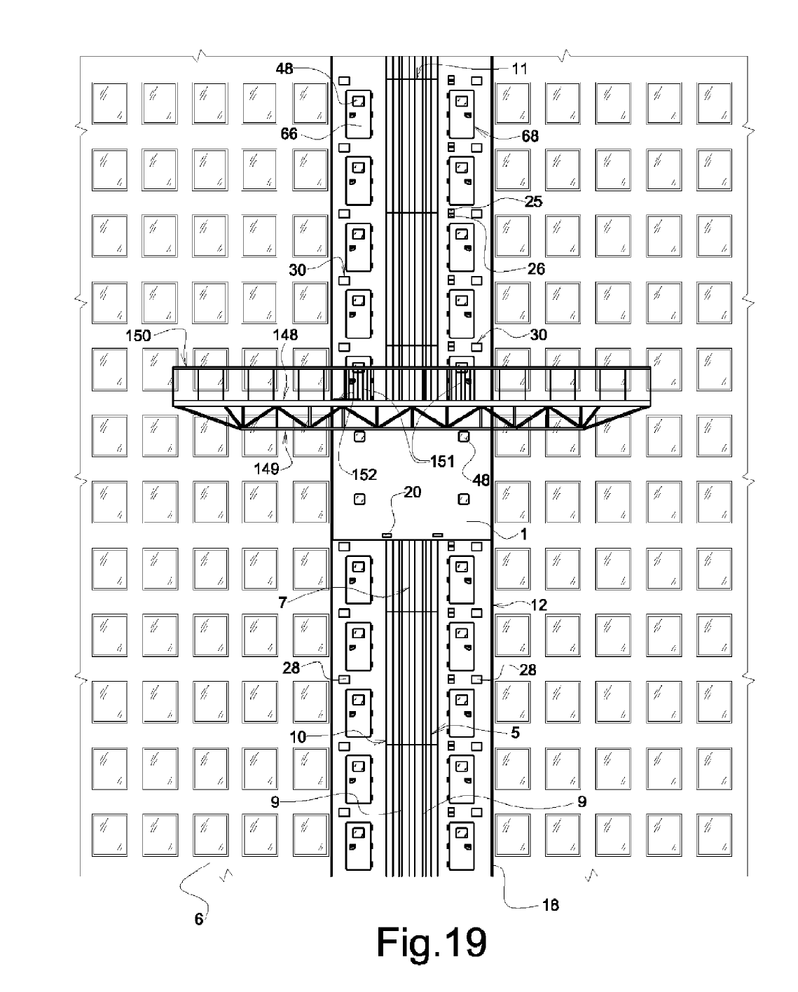

(In order to enable using hoisting tackle 1 as a cargo-lift to lift and lower bulky and heavy cargoes, its upper horizontal surface 33 is equipped with horizontal platform 148 (FIG. 19). Horizontal platform 148 is equipped on its lower surface with metal truss 149 and is provided with fence 150 along its perimeter. To enable communication of horizontal platform 148 with evacuation exists 68 of building 6, fence 150 is provided with sliding wickets 151. To enable communication of horizontal platform 148 with the internal compartment of hoisting tackle 1, hatch 152 is provided on a surface of horizontal platform 148, to which, from its bottom side, ladder 89 of hoisting tackle 1 is mated.

The system's operation is discussed by the example of using a self-relocating lifting tower-type crane.

Hoisting tackle 1 is connected via its running gear (support wheels 2 and drive cog-wheels 3) to removable section 93 of an H-shaped rail (FIG. 1).

Hoisting tackle 1 with removable section 93 of the H-shaped rail is located on self-propelled chassis 53 (FIG. 9). As hoisting tackle 1 is not in operation, it is stored in this position in a special place of storage (for instance, in the construction equipment storage hangar).

After a section of building 6 has been erected on the construction site, together with auxiliary portal 59 and a docking device, self-propelled chassis 53 is removed over there.

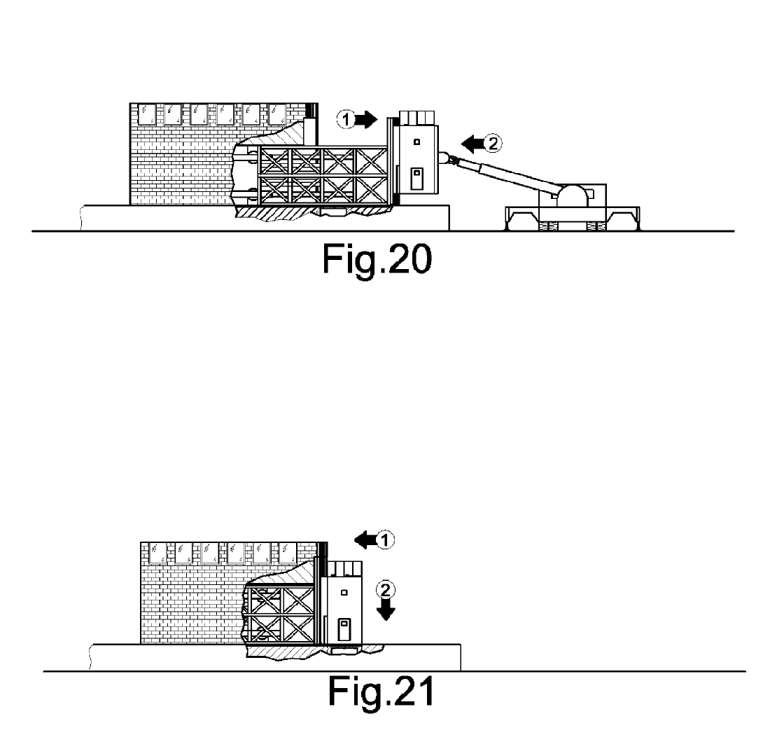

After self-propelled chassis 53 arrives to building 6 under construction, it is placed in immediate vicinity of the docking device and auxiliary portal 59 of building 6. Then, the process of mounting hoisting tackle 1 and removable section 93 of the H-shaped on the docking device of building 6 is started (FIGS. 6 and 20).

Mounting of hoisting tackle 1 and removable section 93 of the H-shaped rail on the docking device of building 6 is performed in the following way:

Telescopic boom 56 is raised up to the level of approximately 45° with regard to operating plane of body 54 of self-propelled chassis 53.

Support 58 remains in strictly horizontal position owing to its rotation gear 57.

Then, with use of rotation gear 55, telescopic boom 56 together with support 58, where hoisting tackle 1 with removable section 93 of the H-shaped rail are installed, is rotated towards the docking device of building 6.

Then, support 58 due to its swivel gear 57 is rotated by 90° into the strictly-vertical position.

At the same time, screw-jack devices 96 are put in motion, which pull out, from functional compartment 94 of the docking device of building 6, pullout frame 95.

As a result of the movement, take-up panel 99 fixed on the outer end of pullout frame 95, is now pulled out onto concrete foundation 41 of auxiliary portal 59 of building 6 (approx. 4 meters long) (FIG. 6).

Smoothness and reliability of the motion for pullout frame 95 are ensured by its support wheels 97, which interact with guides 98 provided in the surfaces of functional compartment 94 and auxiliary portal 59.

Then, telescopic boom 56 is pulled out toward a wall of building 6 as to ensure that the lower part of the outer surface of mounting panel 101 contacts the upper part of the outer surface of take-up panel 99.

Following this, with use of swivel gear 57, support 58 is being aligned until mounting panel 101 is positioned strictly parallel by all of its surfaces in respect to take-up panel 99.

Then, using rotation gear 55, telescopic boom 56 starts moving down.

During the operation, mounting panel 101 will start smooth installation into overlay guides 100 of take-up panel 99 (FIG. 12).

Coordination of the direction and safety during the installation are ensured by chamfered guiding stands 102 of take-up panel 99 and bottom rounded corners 103 of mounting panel 101 (FIG. 12).

After mounting panel 101 has been completely installed (lowered) into overlay guides 100 of take-up panel 99, the upper shear of removable section 93 of the H-shaped rail will be positioned several millimeters below the lower shear of H-shaped rail 5, while vertical symmetry axes of both removable sections 93 of the H-shaped rail and 5 will be strictly parallel.

As long as hoisting tackle 1 is installed on removable section 93 of the H-shaped rail, then, following the above installation, it will be possible to disconnect hoisting tackle 1 from support 58.

To do so, opening 23 in forked elements 21 are released from screw-jack stoppers 22 of hoisting tackle 1.

Then, by pulling in (folding) of telescopic boom 56, longitudinal grooves 20, which are inside of the body of hoisting tackle 1, are released from forked elements 21 of support 58.

Support 58 released as a result of the operation, is then folded and laid in the over-the-road position, on the operating surface of body 54 of self-propelled chassis 53.

Demounting of hoisting tackle 1 and removable section 93 of the H-shaped rail into the over-the-road position shall be performed in the reverse sequence.

Concurrently, screw-jack devices 96 are put in motion, which pull pullout frame 95 into functional compartment 94 of the docking device of building 6.

As a result of the operation, take-up panel 99 fixed on the outer end of pullout frame 95, together with removable section 93 of the H-shaped rail with hoisting tackle 1 positioned on it are moved toward a wall of building 6.

Upon completion of the maneuver, the upper shear of removable section 93 of the H-shaped rail is positioned (at a distance of only few millimeters) below the bottom shear of H-shaped rail 5 and their vertical symmetry axes coincide.

Then, hoisting tackle 1 is moved down on concrete foundation 41, in which metal insert 40 is provided. Using openings 42 and screw couplings 43, bottom horizontal surface 39 of hoisting tackle 1 is fixed on metal insert 40 (FIGS. 7 and 21).

Then, a lifting tower crane is mounted on upper horizontal surface 33 of the given hoisting tackle 1, which consists of several sections 74 of vertical tower-type truss 45, turntable 34, outrigger 35, operator's cabin 36, hauling gear (ropes) 37 and lifting mechanisms of winches 38 (FIG. 5).

After the tower crane has been properly mounted and tested, it is used to erect building 6, and, initially, several stories are built on. Concurrently to erection of building 6, the crane is used to construct, inside the building perimeter, a vertical tower-type structure, which is formed of autonomous sections (floors) 19, and, accordingly, H-shaped rail 5, as long as the latter represents a component of outer surfaces of these sections (floors) 19 (FIG. 5).

As building under construction 6 achieves the altitude where it is already impossible to raise it higher with use of the initially-mounted tower crane, then a necessity appears to increase height of the crane. To enable this, erection of building 6 is temporary suspended, and engineering operations are performed aimed at increasing the height of the tower crane:

Screw couplings 43 are dismantled, which fastened bottom horizontal surface 39 of hoisting tackle 1 on metal insert 40. Then, the tower crane is relocated along H-shaped rail 5 several floors higher.

To do so, driving device 4 is initiated, which is located in the body of hoisting tackle 1. Driving device 4, in its turn, puts in motion drive cog-wheels 3. Drive cog-wheels 3 contact with rack guides 8 of guiding grooves 9 and start moving hoisting tackle 1 up along removable section 93 of the H-shaped rail. Concurrently, support wheels 2 start motion inside guiding grooves 7 thus ensuring stable position of hoisting tackle 1 on the H-shaped rail (FIG. 1).

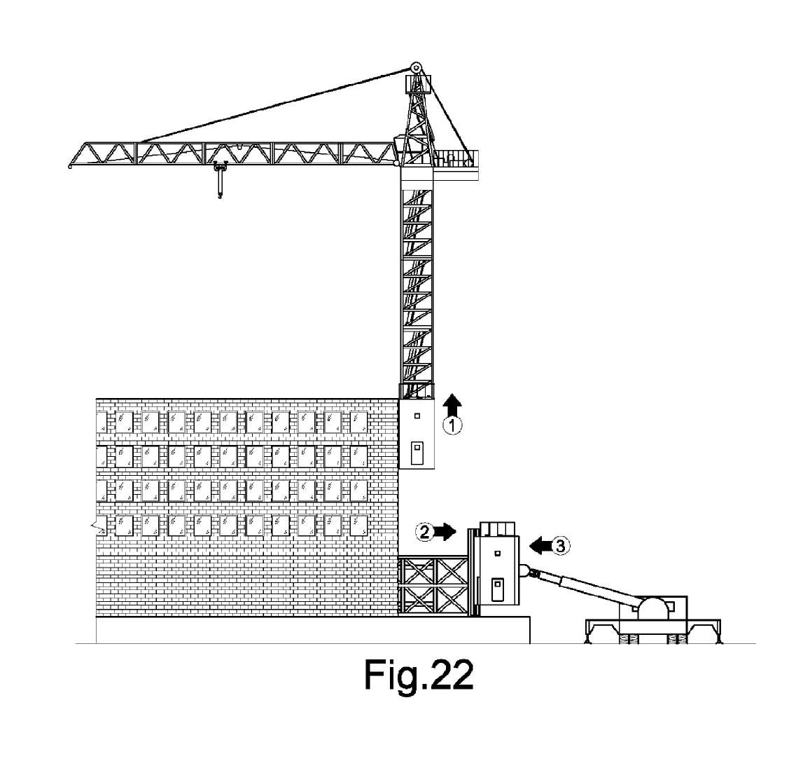

Therefore, hoisting tackle 1 moves from removable section 93 of the H-shaped rail up, onto permanent H-shaped rail 5 installed on the building, and it now can move in both directions along the entire length of H-shaped rail 5 to any altitude level of building 6. Owing to this, the tower crane moves along H-shaped rail 5 several floors higher (pos. 1 of FIG. 22).

Concurrently, pullout frame 95 of the docking devices extends maximally out from the building and, using self-propelled chassis 53, the second hoisting tackle 1 is installed on it (pos. 2 and 3 of FIG. 22).

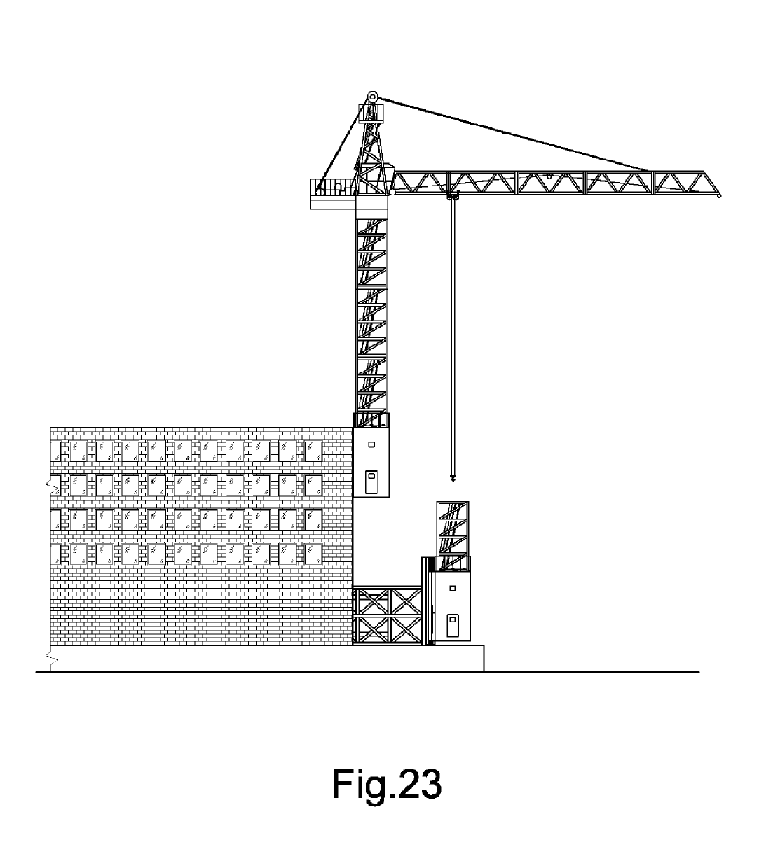

Then, using the tower crane, the first section 74 vertical tower-type truss 45 is mounted on upper horizontal surface 33 of the second hoisting tackle 1. Installation is completed by riggers who are upper horizontal surface 33 of the second hoisting tackle 1. At first, they position section 74 suspended on hauling gear (rope) 37 of the crane, by means of its inserting its mounting pins 75 in grooves 76 of upper horizontal surface 33. Then, they fasten section 74 installed, on upper horizontal surface 33 using openings 42 and screw couplings 43 (FIGS. 1, 11 and 23).

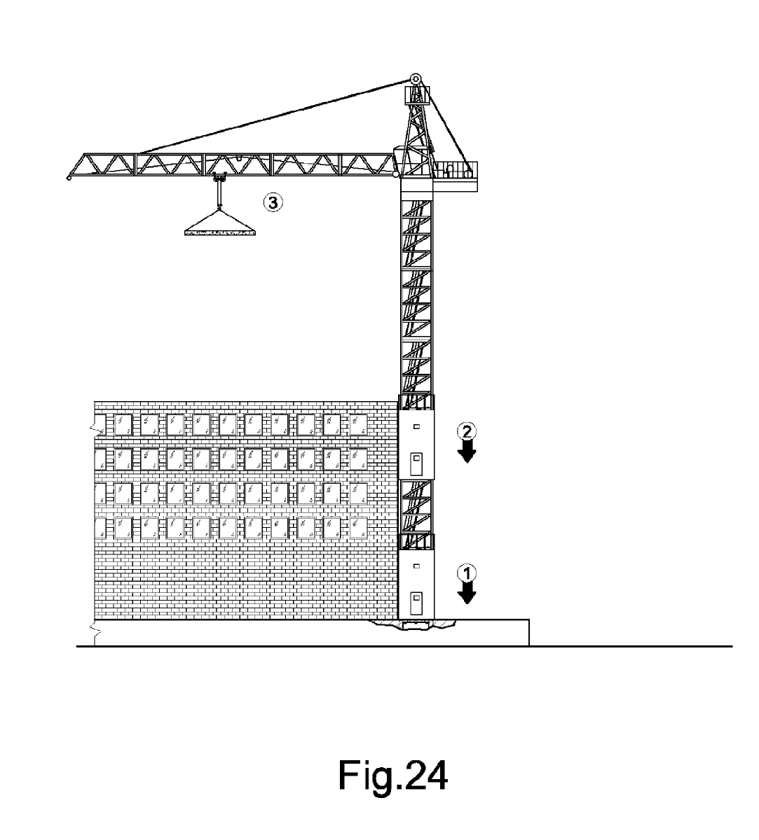

Following this, pullout frame 95 is maximally pulled in to the building, together with the second hoisting tackle 1 installed on it and the first section 74 of vertical tower-type truss 45 installed on the tackle. The second hoisting tackle 1 is moved down onto concrete foundation 41 and fastened metal insert 40, and then the first hoisting tackle 1 is lowered on the upper part of the first section 74 of vertical tower-type truss 45 and fastened on its mounting frame 80. After this, the tower crane is used to erect another several floors of the building (FIG. 24).

After the building is built up, the first section 74 of the vertical tower-type truss is disconnected from upper horizontal surface 33 of the second hoisting tackle 1, and the tower crane is moved on, along H-shaped rail 5, several floors higher. The second hoisting tackle 1 is disconnected from metal insert 40 and moved along removable section 93 of the H-shaped rail several centimeters higher. After that, pullout frame 95 is maximally pulled out from the building, together with the second hoisting tackle 1 installed on it.

Then using the tower crane on upper horizontal surface 33 of the second hoisting tackle 1, the second section 74 of vertical tower-type truss 45 is mounted. Pullout frame 95 is maximally pulled in to the building, together with the second hoisting tackle 1 installed on it and the second section 74 of vertical tower-type truss 45 installed on the given tackle. The second hoisting tackle 1 is moved down on concrete foundation 41 and fastened on metal insert 40, while the first section 74 of vertical tower-type truss 45 is lowered onto the upper part of the second section 74 and fastened on its mounting frame 80. Following this, the tower crane is used to erect another several floors of the building.

In the similar manner, engineering measures are completed aimed at addition to the tower crane mounted of the third hoisting tackle (FIG. 5).

Upon completion of the above operations, mounting of the structure of the lifting tower crane is over. That is why, as soon as the building is built up, the crane is used as a self-relocating crane of the tower type in order to enable continuation of erection works in respect to further floors (levels) of the building. So, as the third hoisting tackle 1 is disconnected from metal insert 40 and the tower crane is relocated along H-shaped rail 5 several floors higher, the crane device is no longer expanded, but instead all its three hoisting tackles 1 are fastened on supporting elements 28 of the building. Following this, the tower crane can be used to erect several more floors of the building.

Fastening of hoisting tackles 1 of the proposed system on supporting elements 28 of the building is completed in the following way. Supporting elements 28 are placed in guiding casings 30 of autonomous section 19 and are pulled out into take-up casings 29 of hoisting tackle 1 either manually or with use of screw-jack devices 31. Upon maximal pulling-in of supporting elements 28 into hoisting tackle 1, these supporting elements 28 are fastened using latches 32 (FIGS. 3 and 11).

The above operations related to movement and temporary fastening of the crane are performed at the point of achieving by the building under construction of the designed altitude and completion of constructing works. The design peculiarities of the proposed crane and vertical tower-type structure formed by autonomous section (floor) 19 enable performance of construction of especially high-rise buildings with height over 300 meters.

When demounting the proposed crane device, its outrigger 35 is rotated so that the outrigger is positioned parallel to the surface of the building on which the given crane is located, and then it is turned down (approx. by 80°). Then, the crane device is moved to the lower part of the building, so that its third hoisting tackle 1 is on the docking device of building 6. Further mounting is performed in the reverse order of the above mounting operations, with only exclusion that an additional crane device is engaged (for instance, a truck-mounted crane).

Some of erected or designed high-rise constructions have stepped shape of their outer surfaces. That is why, in order to enable overcoming by hoisting tackles 1 of the proposed crane device of horizontal cornices during constructing of such constructions with stepped shape of the outer surfaces, transfer junctions are provided on the cornices of such a construction.

Let us consider description of operation of the proposed crane device during construction of building 6 that has a horizontal cornice up to 3 meters wide.

In this case, transfer junction of building 6 required for hoisting tackles 1 of the proposed crane device to overcome the cornices will comprise functional compartment 94, transfer junction of building 6 and pullout frame 95, which is installed in it and connected to screw-jack devices 96 (FIG. 13).

The tower crane that is located on surface B of building 6 has constructed cornice 106 of the building, a transfer junction and several floors on surface A of building 6. As the point sets in when building 6 has achieved the height where it is impossible to build it further while the crane is on surface B, there is necessity to reinstall the crane from surface B to surface A. To enable this, construction of building 6 is temporarily suspended, and operations are performed aimed at overcoming by the tower crane of cornice 106.

For that purpose, the lifting tower crane is moved up along outer surface B of building 6 until its upper (first) hoisting tackle 1 is in immediate vicinity to the edge (outer corner) of cornice 106. At this point, screw-jack stops 119 on the upper end of H-shaped rail 5 positioned on surface B are in position “pulled out”. This is required in order to prevent hoisting tackle 1 (for instance, owing to any failure) from coming off upper end of H-shaped rail 5. As soon as the first hoisting tackle 1 of the tower crane climbed along outer surface B of building 6 to the edge (outer corner) of the cornice and stopped there, personnel remotely, with use of one of control panels 27, activates screw-jack devices 96 of the transfer junction of building 6.

Screw-jack devices 96 pull out and move pullout frame 95 from outer surface A to outer surface B of building 6 (FIG. 13). Reliability and smoothness of the movement is ensured for pullout frame 95 by its support wheels 97, which contact with guides 98 provided on the outer surface of cornice 106 and in the upper part of functional compartment 94.

Pullout frame 95 has in its frontal part outer panel 107 with mobile H-shaped rail section 108 provided on it. That is why when pullout frame 95 is maximally pulled out from functional compartment 94, mobile H-shaped rail section 108 is then contiuous with H-shaped rail 5 equipped on outer surface B of building 6.

Using one of control panels 27, personnel remotely moves into position “pulled in”, screw-jack stops 119 located on the upper end of H-shaped rail 5, which is mounted on outer surface B of the building.

Concurrently with this, personnel, also using one of control panels 27, remotely switches to position “pulled in” screw-jack stops 118 and to position “pulled out” screw-jack stops 117. Both pairs of the stops are located on the mobile section of H-shaped rail 108 (stops 118 in its bottom part, and stops 117 in its upper part).

As a result of the above operations, the way for the first hoisting tackle 1 of the tower crane to the mobile section of H-shaped rail 108 is free. The first hoisting tackle 1 goes there from the upper end of H-shaped rail 5 (located on outer surface B of building 6) after the tackle is disconnected from mounting frame 80 of the first section 74 of vertical tower-type truss 45.

As soon as hoisting tackle 1 of the tower crane has completely shifted to mobile section 108 of the H-shaped rail, personnel, using one of control panels 27, remotely switches to position “pulled out” screw-jack stops 118 that are located in the bottom part of the mobile section.

Then, again with use of one of control panels 27, screw-jack devices 96 are switched on remotely, which start transporting pullout frame 95 with the first hoisting tackle 1 fastened on it toward functional compartment 94 provided on outer surface A of building 6.

As soon as pullout frame 95 is maximally pulled in to functional compartment 94 of the transfer junction of building 6, mobile section 108 of the H-shaped rail will be continuous with H-shaped rail 5 mounted on outer surface A of building 6.

Then, the first hoisting tackle 1 is moved down on the outer surface of cornice 106 of the building and fastened on metal insert 40, and the tower crane is used then to erect several floors of the building.

As soon as the building is built up, the first section 74 of vertical tower-type truss 45 is disconnected from the second section 74 and demounted using the tower crane.

Then the personnel, using one of control panels 27, remotely switches in position “pulled in” screw-jack stops 117 located on the upper end of mobile section 108 of the H-shaped rail. At the same time, screw-jack stops 116 are switched to position “pulled in” which are located on the bottom end of H-shaped rail 5, which is mounted on outer surface A of building 6.

As a result of the above operations, the way for the first hoisting tackle 1 of the tower crane to H-shaped rail 5 mounted on outer surface A of building 6 is free. Finally, the first hoisting tackle 1 is disconnected from metal insert 40, and the lifting tower crane is moved along H-shaped rail 5 several floors higher, and pullout frame 95 of the transfer junction is moved out from the building. The second hoisting tackle 1 is disconnected from mounting frame 80 of the first section 74 of vertical tower-type truss 45 and moved up to the transfer junction of the building.

Pullout frame 95 of the transfer junction is maximally pulled out. The second hoisting tackle 1 moves on mobile section 108 of the H-shaped rail of the transfer junction of building 6. Then, pullout frame 95 is maximally pulled into the building, together with the second hoisting tackle 1 fastened on it and the second section 74 of vertical tower-type truss 45 installed on the tackle.

The second hoisting tackle 1 is moved on the outer surface of cornice 106 of the building and fastened on metal insert 40, and the first hoisting tackle 1 is moved on the upper part of the first section 74 of vertical tower-type truss 45 and fixed on its mounting frame 80. Following this, the tower crane is used to erect several floors of the building.

As soon as the building is built up, the first section 74 of vertical tower-type truss 45 is disconnected from upper horizontal surface 33 of the second hoisting tackle 1, and the tower crane is moved along H-shaped rail 5 several floors higher. The second hoisting tackle 1 is disconnected from metal insert 40 and moved along mobile section 108 of the H-shaped rail several centimeters higher, and pullout frame 95 with the second hoisting tackle 1 is maximally moved out from the building.

Using the tower crane, the second section 74 of vertical tower-type truss 45 is mounted on upper horizontal surface 33 of the second hoisting tackle 1.

After this, pullout frame 95 is maximally pulled in to the building, together with the second hoisting tackle 1 fastened on it and the second section 74 of vertical tower-type truss 45 fastened on the tackle. The second hoisting tackle 1 is moved down on the outer surface of cornice 106 of the building and fastened on metal insert 40, while the first section 74 of vertical tower-type truss 45 is moved down on the upper part of the second section 74 and fastened on its mounting frame 80. Following this, the crane is used to erect several further floors of the building.

In strict compliance with installation and construction operations completed with the first and second hoisting tackles 1, the third hoisting tackle 1 with its two sections 74 of vertical tower-type truss 45 also overcomes the building cornice and connects with the tower crane. The third hoisting tackle 1 moves down on the outer surface of cornice 106 of the building and is then fastened on metal insert 40. The tower crane is used then to erect several further floors of the building.

After the building has been built up, the third hoisting tackle 1 is disconnected from metal insert 40, and the tower crane is moved along H-shaped rail 5 several floors higher. All three hoisting tackles 1 are fastened on supporting elements 28 of building 6, following which the tower crane is used to erect several further floors of the building.

Overcoming by the proposed crane device of the cornice in the reverse direction, which is during coming down, is performed in the reverse order of steps.

Overcoming of the cornice in both directions by additional hoisting tackle 46 and hoisting tackle 1 equipped with horizontal service platform 148 is performed in the same order.

Let us consider operation of the proposed crane device during construction of building 6 which has a horizontal cornice over 3 meters wide:

In this case, the technical device required in order for hoisting tackles 1 of the tower crane to overcome the cornice consists of functional compartment 94 of transfer junction of building 6 and self-propelled module 109 installed in it. This self-propelled module 109 is equipped with driving unit 110 and a running gear comprising support wheels 113 and drive cog-wheels 111 (FIG. 14).

Lifting tower crane located on surface B of building 6 have erected cornice 106 of the building, transfer junction and several floors on surface A of building 6. As the point sets in when building 6 has achieved the height where it is impossible to build it further up while the crane is on surface B, there is necessity to reinstall the crane from surface B to surface A. To enable this, construction of building 6 is temporarily suspended, and operations are performed aimed at overcoming by the tower crane of cornice 106.

For that purpose, the first hoisting tackle 1 of lifting tower crane is moved up along outer surface B of building 6 toward the edge (outer corner) of this cornice. On the top end of H-shaped rail 5, screw-jack stops 119 are switched to position “pulled out”.

After hoisting tackle 1 of lifting tower crane has climbed along outer surface B of building 6 to the edge (outer corner) of this cornice and stopped, personnel, using one of control panels 27, remotely activates driving unite 110.

Driving unit 110 put in motion drive cog-wheels 111. Using these drive cog-wheels 111 and rack guides 112 that are in contact with them, self-propelled module 109 moves from functional compartment 94 beyond the limits of outer surface A towards outer surface B of building 6 (FIG. 14).

Reliability and smoothness of the movement is ensured for self-propelled module 109 through its support wheels 111, which contact with guides 114 provided on outer surface of cornice 106 of building 6.

Self-propelled module 109 has, in its frontal part, outer panel 115 with mobile section 108 of the H-shaped rail installed on it. That is why as self-propelled module 109 is maximally pulled out from functional compartment 94, mobile section 108 of the H-shaped rail be continuous with H-shaped rail 5 mounted on outer surface B of building 6.

Personnel, using one of control panels 27, remotely switch into position “pulled in” screw-jack stops 119 located on the top end of H-shaped rail 5 which is mounted on outer surface B of building 6.

Concurrently, personnel, also using one of control panels 27, remotely switches into position “pulled in” screw-jack stops 118 and into position “pulled out” screw-jack stops 117. Both pairs of the stops are located on the mobile section of H-shaped rail 108 (stops 118 in its bottom part, and stops 117 in its upper part).

As a result of the above operations, the way for the first hoisting tackle 1 of the lifting tower crane to the mobile section of H-shaped rail 108 is free.

Further description of installation and construction operations used for the crane device to overcome the horizontal cornice over 3 meters wide is precisely similar to the above operations in respect to overcoming by the proposed crane device of a horizontal device up to 3 meters wide.

When erecting modern high-rise constructions, various crane devices of the tower type are utilized. That is why for purpose of broadening its functionalities, the proposed crane device can be also used as a fixed self-erected lifting tower crane.

Let us consider the stage of construction represented in FIG. 24, which has already been discussed above when operation of a self-relocated lifting tower crane is described. At the stage of construction works, it is possible to start using the proposed crane device as a fixed self-erected lifting tower crane.

To do so, mounting swivel ground 122 is mounted on upper hoisting tackle 1 of the lifting tower crane. The mounting is performed through inserting of forked elements 123 of removable frame 120 into longitudinal grooves 20 of such hoisting tackle 1 and further fastening of forked elements 123 in longitudinal grooves 20 with screw-jack stoppers 22 via openings 125 (FIG. 15). Besides, the procedure of mounting includes blocking with locking devices 134 of rotary frame 127.

After mounting swivel ground 122 is suspended and fastened on the outer surface of upper hoisting tackle 1, the lifting tower crane is used to erect several further floors of the building.

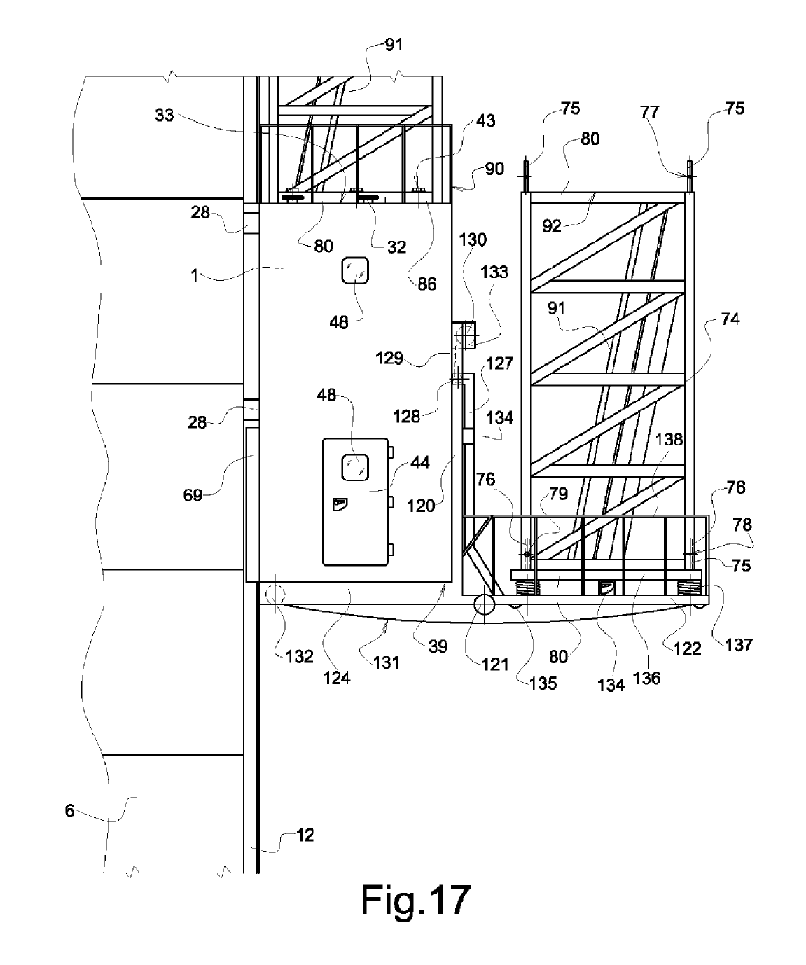

After the building has been built up, section 74 of vertical tower-type truss 45 is disconnected from bottom horizontal surface 39 of upper hoisting tackle 1, and the lifting tower crane is moved along H-shaped rail 5 several floors higher. Then, using the lifting tower crane, new section 74 of vertical tower-type truss 45 with its mounting pins 75 up is installed on mounting swivel ground 122 (FIG. 17).

In this installation, riggers participate who are on mounting swivel ground 122. At first, they position section 74 suspended on hauling gear (rope) 37 of the crane, by means of its inserting its mounting pins 75 in grooves 76 located in the poles of section 74. Then, they fasten section 74 installed, on service platform 136 with use of openings 78 and 77 and screw couplings 79 and, using locking devices 134, unblock rotary frame 127 (FIG. 15, 17).

Following this, mounting swivel ground 122 is rotated down by 180°. In order to enable such rotation, winch 130 is switched to uncoil rope 129, and winch 132 is switched to wind up ropes 131. As a result of the operation, mounting swivel ground 122 together with new section 74 of vertical tower-type truss 45 smoothly turn down by 180° until elastic elements 135 set against support shafts 124. Then, locking devices 134 of service platform 136 are unblocked.

As a result of the maneuver, new section 74 of vertical tower-type truss 45 will be suspended on service platform 136 turned its mounting pins 75 down. The vertical symmetry axis of section 74 will coincide with the vertical symmetry axis of section 74 of vertical tower-type truss 45 fastened on upper horizontal surface 33 of the second hoisting tackle 1.

Then, the lifting tower crane is moved along H-shaped rail 5 several meters down until the first and second sections 74 of vertical tower-type truss 45 mate. Following this, sections 74 are fastened to each other. In this mounting operation, riggers are involved who are on transfer grounds 92 and mounting pads 145 of these two sections 74. At first, they position upper section 74 suspended on service platform 136 through inserting its mounting pins 75 in grooves 76 located in poles of lower section 74. Then, they fasten upper section 74 mounted on lower section 74, using openings 78 ad 77 and screw couplings 79.

Then, upper section 74 of vertical tower-type truss 45 is disconnected from service platform 136 of mounting swivel ground 122, and the lifting tower crane is moved along H-shaped rail 5 several meters higher, following which mounting swivel ground 122 is turned up by 180°. To do this, winch 130 is switched to wind up rope 129 and winches 132 to unwind ropes 131. As a result of the operation, mounting swivel ground 122 smoothly turns up by 180°, in its starting position. Rotary frame 127 is blocked with locking devices 134 and mounting swivel ground 122 is ready to accommodate new section 74 of the vertical tower-type truss.

After that, the lifting tower crane is moved along H-shaped rail 5 several meters down until upper section 74 of vertical tower-type truss 45 connects with bottom horizontal surface 39 of upper hoisting tackle 1. This section 74 of vertical tower-type truss 45 is fastened with upper horizontal surface 33 of upper hoisting tackle 1 using removable mounting pins 81, grooves 76, openings 42 and screw couplings 43. After this, the lifting tower crane is used to erect several further floors of the building.

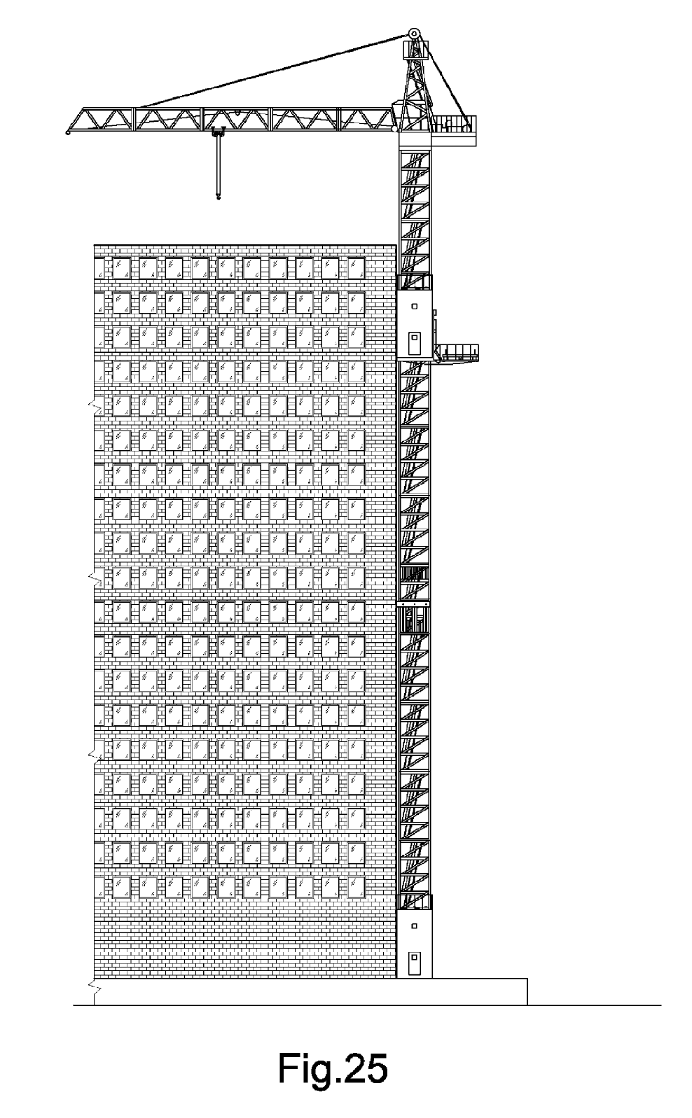

Mounting operations related to installation sections 74 of vertical tower-type truss 45 using mounting swivel ground 122 are repeated as long as necessity exists to increase the height of the lifting tower crane during erection of the high-rise building. By way of an instance, FIG. 25 illustrates the stage of construction works when between upper and lower hoisting tackles 1, there are already eight sections 74 of vertical tower-type truss 45 installed, and the building is erected 19 floors high. The fifth section 74 from the bottom has mounting balconies 142 that are fixed with the building using supporting elements 28. There is also possibility to fasten to the building using supporting elements 28 upper hoisting tackle 1 of the lifting tower crane, too.

Demounting of the proposed crane device is performed in the following way.

Using the lifting tower crane, several riggers and mounting swivel ground 122, all sections 74 of the vertical tower-type truss are demounted between upper and lower hoisting tackles 1. Then, using the docking device of the building and self-propelled chassis 53, lower hoisting tackle 1 is dismantled. After this, outrigger 35 of the lifting tower crane is turned so as to ensure that its position is parallel to the surface of the building on which this crane is located. Then, the crane device is moved down to the lower part of the building in order to ensure remaining hoisting tackle 1 is on the docking device of building 6. Further dismantling is performed in the reverse order of the above mounting operations, however using an additional crane device, such as a truck-mounted crane.

In order to operate together with the proposed crane device during erection of a high-rise building, additional hoisting tackle 46 and hoisting tackle 1 equipped with horizontal service platform 148 can be used. The former is used to lift and lower personnel and small-size cargoes, and the latter is used to lift and lower bulky cargoes (FIGS. 8 and 19).

After construction of the building is completed and it is put in operation, autonomous section (floor) 19 can be used as stairways of the building and in emergencies, such as fire, as the ‘safety floors’ intended to shelter and evacuate people and property. H-shaped rail 5, the docking device and the transfer junction of building 6 can be henceforward used to lift and lower various hoists intended for construction and repairing/maintenance operations and in case of emergencies—to evacuate people and property. In case of demolition of a high-rise building, the proposed crane device is again installed on H-shaped rail 5 and used to demount the building.

The example of a lifting system intended for erection of a construction with curvilinear wall profile, such as a television tower, is presented below.

According to this invention, the lifting system is discussed intended to operate on high-rise buildings of the tower-type with a round cone-shape design of its body and curvilinear profile of its outer surfaces.

The system comprises the following elements.

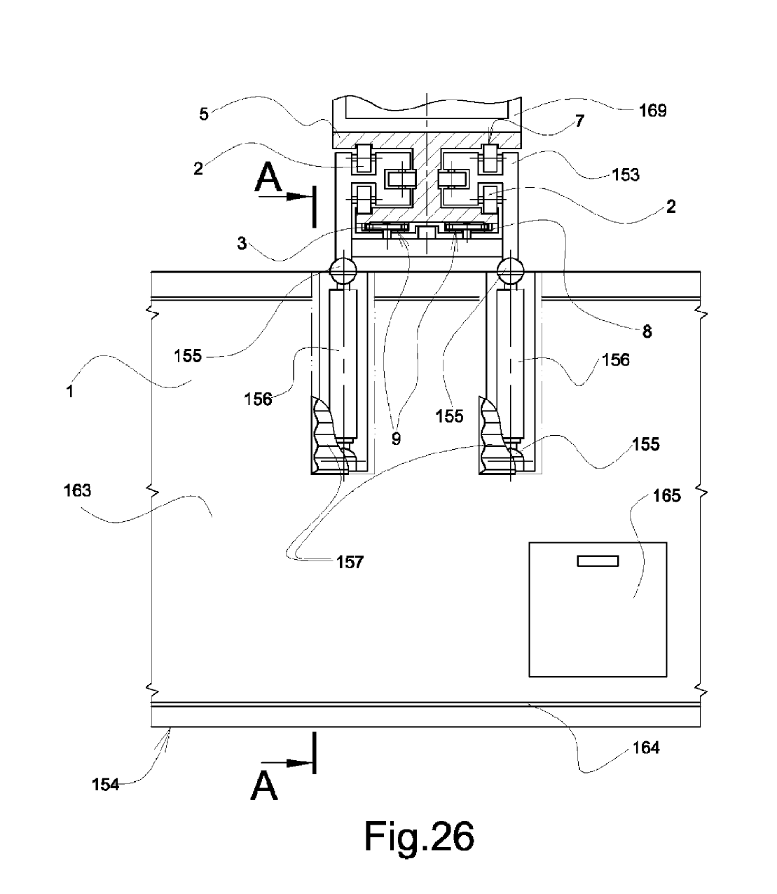

As it was described above, hoisting tackles 1 have completely identical running gears comprising support wheels 2 and drive cog-wheels 3 (FIG. 26), which are installed on dolly 153 of the running gear. Drive cog-wheels 3 are driven from driving units 4. Using their running gears, hoisting tackles 1 can move along rails 5, which have an H-shaped profile. H-shaped rails 5 are installed on outer surfaces of high-rise building 6. This is enabled due to contact of support wheels 2 and drive cog-wheels 3 with guiding grooves 7 and rack guides 8 of H-shaped rail 5, respectively.

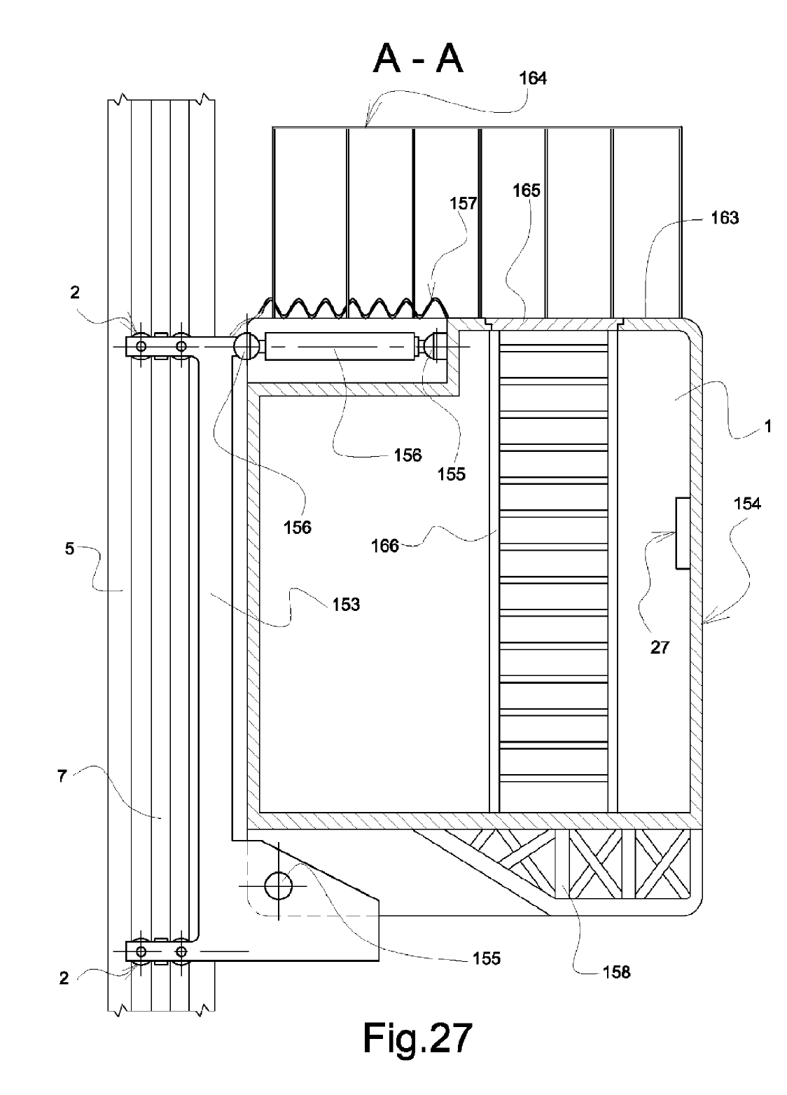

Running gear dolly 153 of each hoisting tackle 1 is movably connected with cargo and passenger cabin 154 by means of flexible swivel blocks 155 and screw-jack guides 156 (FIG. 27).

As an alternative, dolly 153 of the running gear of hoisting tackle 1 can be movably connected with cargo and passenger cabin 154 using only screw-jack guides 156.

Spacing between running gear dolly 153 and cabin 154 of hoisting tackle 1 is covered with elastic corrugated casing 157 (FIG. 27).

The distance between the groups of support wheels 2 provided on running gear dolly 153 of hoisting tackle 1 is sufficient to enable movement along rail 5 with curvilinear line that repeats curvatures of building 6, where the system is installed (FIG. 27).

For the same purpose, support wheels 2 are fastened on surfaces of running gear dolly 153, at least, via springs.

Cabin 154 of hoisting tackle 1 has a rigid skeleton and a hermetic casing made of heat-resistant material.

Cabin 154 is installed on truss section 158 for purpose of strengthening its structure (FIG. 27).

Cabin 154 of each hoisting tackle 1 is made with heat-resistant hermetically-closed doors 44 intended for communication with entries of building 6 and/or cabins 154 of other hoisting tackles 1.

Cabin 154 of hoisting tackle 1 is provided with heat-resistant hermetically-closed windows 48.

Structural components of hoisting tackle 1 are equipped as a minimum with searchlights, video cameras, loudspeakers, voice intercom devices, navigation devices, and sensors of temperature, distance, air pollution and wind and weight loads. The structural components are also equipped at least with compartments to store fire-extinguishing foam and other process liquids, terminals to connect pipelines and power cables, and compartments to store auxiliary equipment. Functional compartments of hoisting tackle 1 have, at least, reliable hermetic heat-resistant outer coating, internal illumination, an air cleansing and conditioning system, oxygen masks, a first-aid kit to render first medical aid, and fire-fighting and other technical equipment (depending on equipment type).

All hoisting tackles 1 of the lifting system are equipped with mechanical safety brakes that ensure deceleration of lowering or stop of the system in case of accident.

Hoisting tackle 1 is operated by personnel both from inside using control panel 27 located in the internal compartment of the tackle, and outside using a remote control panel (FIG. 27).

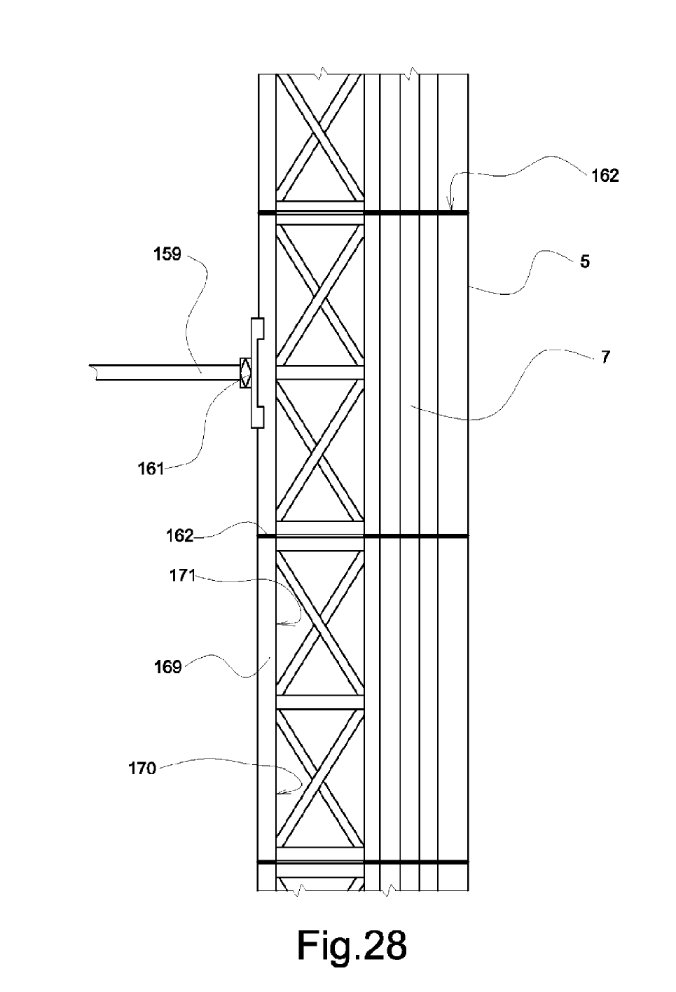

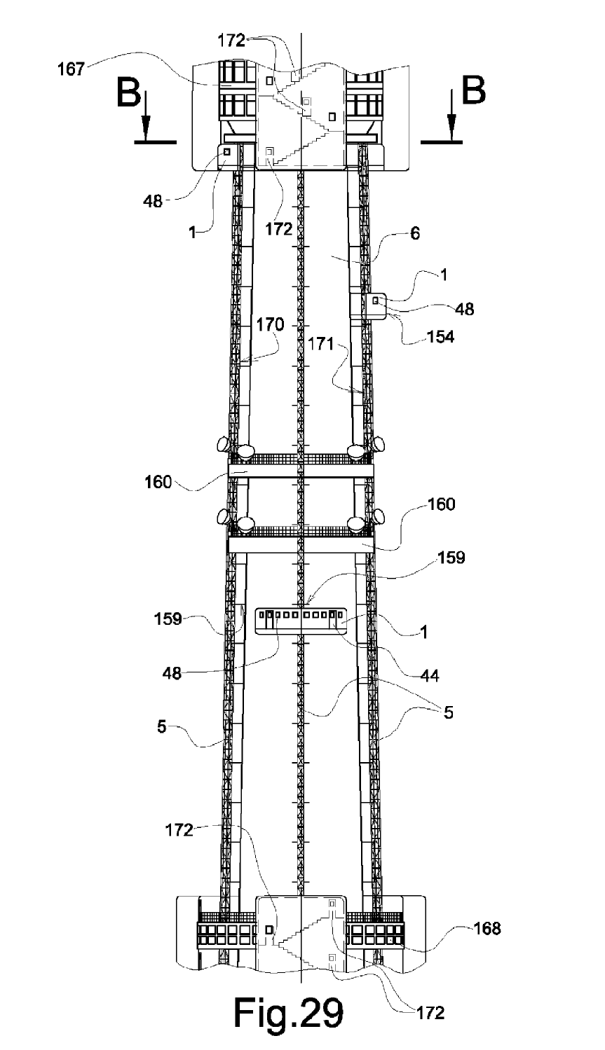

Building 6 has on its outer surfaces several lines of H-shaped rail 5 (FIG. 29) that are permanently mounted along the entire altitude of the project and repeat after its curvilinear profile. Rails 5 are mounted on the outer surface of building 6 vertically and at a distance from each other in circular direction around its outer surface, and are at least in two areas located along the altitude of the building. H-shaped rail 5 is fixed with its inside surface on metal consoles 159, which are installed at a distance from each other along the length of the rail on the surface of building 6 on top of its functional elements and superstructures 160 (balconies, grounds, ladders, etc.) (FIG. 28).

H-shaped rails 5 are fastened on metal consoles 159 via damping units 161 (FIG. 28).

At each section of H-shaped rail 5, in equal intervals of its length, and over the entire area of its horizontal section, temperature-compensating inserts 162 are provided (FIG. 28).

On roof of cabin 154 of hoisting tackle 1, external ground 163 with collapsible fence 164 as well as hatch 165 to which ladder 166 from the internal compartment of cabin 154 are provided (FIG. 27).

Sections of H-shaped rails 5 are fastened with their bottom parts at least on a concrete foundation building 6 or on bearing elements of its riggings.

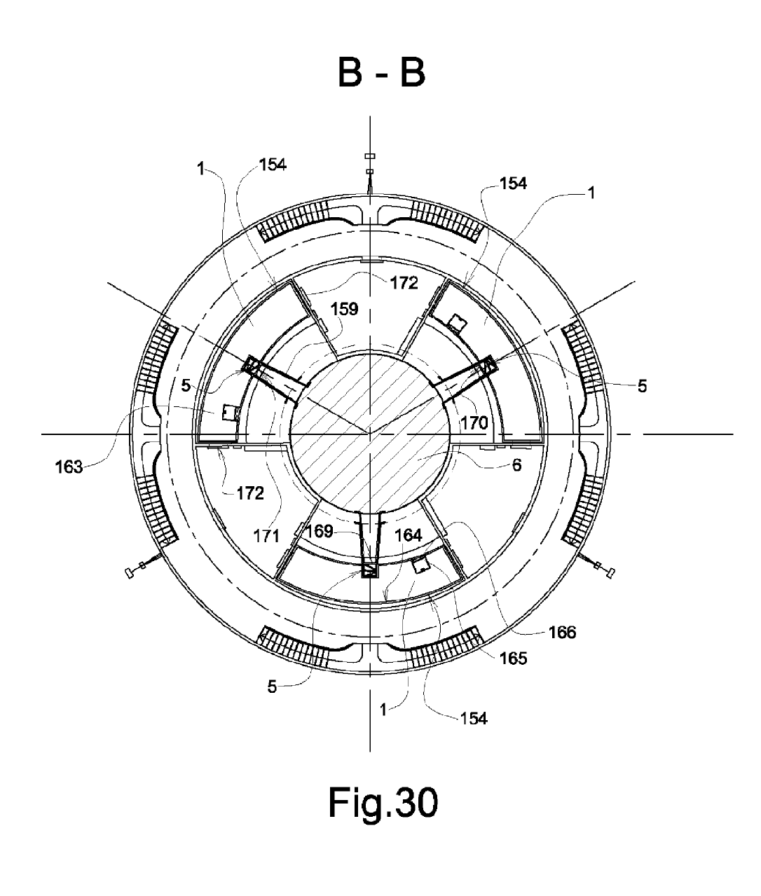

Sections of H-shaped rails 5 are grouped into a single stanchion, which goes through permanent riggings 167 and 168 of high-rise building 6, through openings provided in the floors of rigging bodies (FIGS. 29 and 30).

As it can be seen from FIG. 28, H-shaped rails 5 are fastened on at least stanchions of metal skeleton 169.

Stanchions of metal skeleton 169 with rails 5 installed on them are installed at least on metal consoles 159 installed at intervals from each other along the line of H-shaped rail 5 on surface of building 6 on top of its functional elements and superstructures 160 (balconies, grounds, ladders etc.).

Stanchions of metal skeleton 169 with H-shaped rails 5 installed on them can be mounted directly on surfaces of building 6 too.

Sizes of cross-sections of stanchions of metal skeleton 169 enable laying the line of H-shaped rail 5 on top of the building's functional elements and superstructures 160 (balconies, grounds, ladders etc.).

Sections of stanchions of metal skeleton 169 are fastened with their lower parts at least on the concrete foundation of building 6 or on bearing elements of its riggings.

Sections of stanchions of metal skeleton 169 are at least grouped into a single stanchion, which goes at least through the permanent riggings of high-rise building 6, through openings provided in the floors of bodies of riggings 167 and 168 (FIG. 30).

Temperature-compensating inserts 162 are provided in the bearing elements of the structure of the stanchions of metal skeleton 169, over entire area of their horizontal sections and at equal vertical intervals.

On the rear surface of H-shaped rail 5, pipeline 170 and electric cable 171 are provided that function independently on similar facilities of building 6.

Terminals are connected to stand-alone pipeline 170 and power cable 171, which are located on the façade of the building at a distance sufficient to enable access, at least, to one of the terminals from individual hoisting tackle 1 as it is positioned at any altitude level of building 6.

In order to ensure protection from adverse weather exposures, bodies of rails 6 and stanchions of metal skeleton 169 are equipped with heating elements connected to a self-contained power-supply source.

There are hermetic heat-resistant doors 172 in permanent riggings 167 and 168 intended for communication with internal cabins (FIG. 29).

As one can see on the drawings (FIGS. 29 and 30), for purpose for the design of building 6 under consideration, there are three independent lines of H-shaped rails 5 installed. The rail lines are permanently installed along the entire heights of their respective sections of the TV tower and repeat its curvilinear outline. At the same time they are installed on metal consoles 159 on the surface of building 6 on top of its functional elements and superstructures 160 (balconies, grounds, ladders etc.).

Each of the three rail lines is installed during mounting so that its vertical symmetry line is positioned in the middle between collapsible six-meter radio aerials. On the other hand, each of three lines of H-shaped rails 5 is provided with individual hoisting tackle 1, which can move up and down along the entire lengthy of its respective rail.

It must be noted here that for the areas of building 6 that are of a constant angle in respect to the elevation, hoisting tackles 1 are made as to ensure that their cargo and passenger cabins 154 are installed fixedly on running gear dollies 153 on a certain angle, at which vertical symmetry axes of passenger and cargo cabin 154 and the TV tower coincide. The option of the technical completion of the lift is necessary in order to ensure that during movement of hoisting tackle 1 on H-shaped rail 5 declined on a certain angle, lift cabin 154 remains in a strictly vertical position in any place of the rail (FIG. 29).

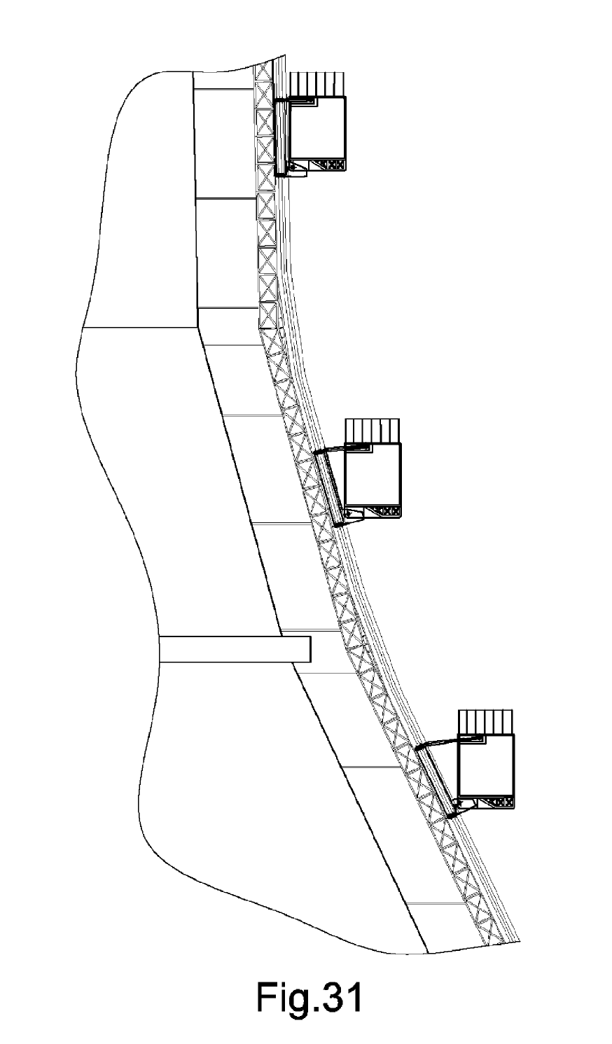

For the areas of surfaces of building 6 with a variable angle in respect to the elevation, hoisting tackles 1 are made as to ensure their passenger and cargo cabins 154 are movably connected with dollies 153 of the running gear with use of flexible swivel blocks 155 and screw-jack guides 156. The alternative of technical completion of the lifting system is necessary in order to ensure that during movement of hoisting tackle 1 on H-shaped rail 5 that has a curvilinear outline, cabin 154 of the lift remained a strictly vertical position in any place of the rail (FIG. 31).

Let us consider operation of the lifting system by the example of its using for purpose of people's evacuation in event of fire.

The proposed lifting system can enable mass people evacuation. According to preliminary estimates by the authors, the systems allows simultaneous transportation of at least 200 persons provided the sufficient carrying capacity is ensured.

To perform people's evacuation, first of all doors 172 of permanent riggings 167 and 168 are opened. People that were in the riggings come through the doors to the parking grounds for cabins 154.

As soon as the tackles are stopped immediately by the parking grounds, doors 44 of cabins 154 of hoisting tackles 1 are positioned directly opposite doors 172 of riggings permanent riggings 167 and 168 (FIG. 29).

Then doors 44 and 172 are opened, and people transfer from riggings 167 and 168 inside cabins 154 of hoisting tackles 1. As soon as hoisting tackles 1 are maximally loaded with the evacuees and loads, doors 44 and 172 are closed and all full hoisting tackles 1 go down.

Then, doors 44 are closed again and the evacuees go down from hoisting tackles 1 to the ground, thus evacuation procedure for the group of people comes its end. Their places in hoisting tackles 1 are then occupied by firemen with portable fire-fighting equipment.

During subsequent similar stages of the above-described rescuing operation, the remaining groups of evacuees are transported to the ground and evacuation for them is over too. At the same time, a group of firemen and portable fire-fighting equipment are delivered to the fire center in the building, where all actions required to extinguish fire and eliminate its effects are undertaken.

Obviously, many modifications and variations of the present invention are possible in light of the above teachings. It is therefore to be understood that, within the scope of the appended claims, the invention may be practiced otherwise than as specifically described.

1-39. (canceled)

40. A lifting system for servicing of high-rise buildings comprising, a vertically-positioned rail mounted on an outer surface of a building, at least one hoisting tackle attached to the rail, and a power source in the hoisting tackle to drive the hoisting tackle on the rail, a vertical truss on the hoisting tackle, the truss having a turntable on the top thereof, an outrigger on the turntable, an operator's cabin on the outrigger and a hauling and lifting mechanism on the outrigger.

41. A lifting system for servicing of high-rise buildings as in claim 40 wherein, at least two hoisting tackles are attached to the rail and rigidly connected to each other.

42. A lifting system for servicing of high-rise buildings as in claim 41 wherein, the vertical truss comprises assembled sections and the hoisting tackle has an outside horizontal surface with mounting pads on which the assembled sections are mounted.

43. A lifting system for servicing of high-rise buildings as in claim 42 wherein, the assembled sections have grooves and on end, the hoisting tackle has an upper surface with removable mounting pins which fit into grooves in the assembled sections.

44-80. (canceled)
